(19) United States
(12) Patent Application Publication
(10) Pub. No.: US 2014/0070652 A1
(43) Pub. Date: Mar. 13, 2014

(54) Magnetic Rotor Turbine Electricity Generator

(71) Applicant: Alibin Shah Emir Jahr Drayton, Bronx, NY (US)

(72) Inventor: Alibin Shah Emir Jahr Drayton, Bronx, NY (US)

(21) Appl. No.: 14/026,055

(22) Filed: Sep. 13, 2013

Related U.S. Application Data
(60) Provisional application No. 61/700,466, filed on Sep. 13, 2012.

(51) Int. Cl. H02K 21/00

(52) U.S. Cl. CPC H02K 21/00; H02K 53/00
USPC 310/152; 74/DIG. 9

(57) ABSTRACT

The invention relates to a method for operating a turbine with an electric generator which can be driven by magnetic rotor/s in order to output electric power to an electricity consumer, storage or an electricity network. The invention also relates to a turbine with magnetic rotor/s and an electric generator coupled to the rotor/s in order to output electric power to an electricity consumer, storage and an electricity network. The invention also relates to a turbine with magnetic rotor/s coupled with a battery powered R/C or manual controlled stabilizer system that allows users of the turbine to control the start stop and restart functions. The invention also relates to a turbine with magnetic rotor/s and an electricity generator where the generator is coupled with a thermo coupling. The aim of the invention is to provide a turbine which avoids the disadvantages pertaining to wind turbines, which especially avoids excess energy loss as heat to the surroundings and which avoids an undesired termination or pause in electricity generation. To this end the inventive method is provided such that the power supplied to the network, storage or electricity consumer by the turbine is regulated according to the relevant materials used to compose the medium administrating the reintroduction of energy lost and the stabilizer system.

### BACKGROUND

This relates to turbines and electricity generators specifically the rotors on turbines, the insulation of the electric generator boxes their corresponding transformer boxes and a stabilizer system having a means that allow users to produce or manufacture eco-friendly renewable sustainable clean energy as well as a means to voluntarily start stop and restarting that production of electricity. At present wind and hydro electric turbines are the most common means of producing sustainable renewable clean energy but are inefficient at producing electricity generated on a massive scale which has to be supplemented by fossil fueled electricity generators, Hydro electricity generators, solar powered electricity generators and nuclear powered electricity generators. Wind turbines are being manufactured to increase the electricity produced by redesigning the way in which the wind turbines interact with the wind, but without the necessary amount of land mass needed to support these structures dependency on fossil fuels and nuclear power is still evident. This flaw renders them inefficient at producing enough electricity to supply an electricity network alone. Heat produced by the reaction of manufacturing electricity is lost to the surroundings exothermically in approximately the equal amount of that electricity manufactured by the reaction. An other area of insufficiency of both the hydro and wind turbines is involuntary termination of electricity generation. Though hydro electric turbines can continuously run as long as nothing obstructs the water current from rotating the rotors and the force supplied by water continues they still do not produce a sufficient amount of electricity, and the same can not be said for wind turbines, though virtually nothing can obstruct the wind current from rotating a wind turbines rotors unlike water current, wind current does not always move in a straight line in the same direction. Due to the previously stated facts interruption of electricity production occurs in both systems involuntarily.

### FIELD OF THE INVENTION

The invention relates to the field of the turbine electricity generators in particular the turbine generators using magnetic rotor/s, magnetic stabilizer mechanisms and thermo coupling liners. The electricity generator of the presented invention is based upon the same laws of electromagnetism utilized in conventional generators. The invention also relates to the field of thermodynamics in that it uses a method for reclaiming energy lose in a system as heat and utilizing that residual heat of a system component and or warm product to generate electricity.

### OPERATION

In operation one uses the magnetic rotor turbine electricity generator in a normal manner. The user when desired can start stop and restart the production of electricity by employing the telescoping magnetic stabilizer either manually (on devices that allow manual operation) or by R/C control. Depending on the device model there are eight ways to employ the effect of the magnetic stabilizer to the magnetic rotor turbine electricity generator that start stop and restart the generation of electricity:
1. on the horizontal single outer rotor single inner rotor device a single telescoping arm is deployed from the stabilizer housing out into the area between the two single rotors to deliver the stabilizers effects
2. on the vertical single outer rotor single inner rotor device a single telescoping arm is deployed from the stabilizer housing up into the area between the two single rotors to deliver the stabilizers effects
3. on the horizontal inner ring rotors and stable single outer rotor device a single telescoping arm is deployed from the stabilizer housing out into the area between the single stable rotor and the inner ring rotors to deliver the stabilizers effects
4. on the vertical inner ring rotors and stable single outer rotor device a single telescoping arm is deployed from the stabilizer housing up into the area between the single stable outer rotor and the inner ring rotors to deliver the stabilizers effects
5. on the horizontal inner ring rotors and single mobile rotor device dual telescoping arms are deployed from the two stabilizer housings out into the area between the mobile single rotor and the inner ring rotors to deliver the stabilizers effects
6. on the vertical inner ring rotors and single mobile rotor device dual telescoping arms are deployed from the stabilizer housing up into the area between the mobile single rotor and the inner ring rotors to deliver the stabilizers effects
7. on the horizontal dual ring rotors (outer and inner rings) device dual telescoping arms are deployed from the two stabilizer housing out into the area between the outer ring rotors and the inner ring rotors to deliver the stabilizers effects
8. on the vertical dual ring rotors (outer and inner rings) device dual telescoping arms are deployed from the stabilizer housing up into the area between the outer ring rotors and the inner ring rotors to deliver the stabilizers effects
9. when electricity is being generated meaning the arm/s of the stabilizer are not in operation and secured inside of the stabilizer housing, electricity manufacturing occurs due to the rotational energy initiated by the repulsive force of the magnetic rotor/s. The rotational energy generated by the rotors is translated to a plurality of rotational energy connectors and translators by means of arrangements of shaft inside of shaft or rod inside of shaft systems. This network of systems, magnetic rotor/s systems attached to shaft inside of shaft and or rod inside of shaft system attached to the rotational energy translator systems supplies the energy needed to build up an amount of voltage inside of the generator boxes that is distributed from the generator boxes to the transformer boxes. Inside the transformer boxes the voltage is converted into useable AC or DC current that can either be stored in a battery or used directly by an electric energy consumer of electricity network. Given the explanation of an exothermic reaction by the laws of chemistry and physics the reaction of generating electricity also radiates energy in the form of heat. This exothermic energy radiated by the system is calculated to be approximately equal to or about half of the amount of electricity actually generated, that being a combined effort of the generator boxes and the transformer boxes. The improvement to the design of both the generator boxes and the transformer boxes with the thermo coupling or semi conductor lining not only will increase the efficiency of the magnetic turbine electricity generators ability to produce renewable clean electricity but will also reduce the amount of global warming it and electricity generators currently used world wide produce to date. There are eight ways the rotational energy created by the magnetic rotor/s when magnetic stabilizer is not in use can be translated to the plurality of rotational energy translators:
1. the horizontal dual rod inside a dual shaft system where both the rods and shafts are mobile which suites the horizontal single inner and single outer mobile magnetic rotor device
2. the vertical single inner rod inside a single middle shaft inside a single outer shaft system where the inner rod, middle shaft and outer shaft are mobile which suites the vertical single inner and single outer magnetic rotor device
3. the horizontal dual rod inside a dual shaft system where only the rods are mobile and the shafts are immobile which suites the horizontal mobile inner ring magnetic rotors and stable single outer magnetic rotor device
4. the vertical single immobile inner rod inside a mobile middle shaft inside an immobile outer shaft system where only the middle shaft is the rotational energy connector to the rotational energy translators which suites the vertical mobile inner ring magnetic rotors and stable single outer magnetic rotor device
5. the horizontal mobile dual inner rod and mobile dual outer shaft system where both the rods and shafts are the rotational energy connectors to the rotational energy translators which suits the horizontal mobile inner ring magnetic rotors and mobile single outer magnetic rotor device
6. the vertical mobile single inner rod inside a mobile single middle shaft inside a mobile single outer shaft system where the rod and both shafts are the rotational energy connectors to the rotational energy translators which suites the vertical mobile inner ring magnetic rotors and mobile single outer rotor device
7. the horizontal dual mobile inner rod and dual mobile outer shaft system where both rods and shafts are the rotational energy connectors to the rotational energy translators which suites the horizontal mobile outer ring magnetic rotors and mobile inner ring magnetic rotors device
8. the vertical single mobile inner rod inside a single mobile middle shaft inside a single mobile outer shaft system where the rod and shafts are the rotational energy connectors to the rotational energy translators which suites the vertical mobile outer ring magnetic rotor and mobile inner ring magnetic rotor device

### BRIEF DESCRIPTION

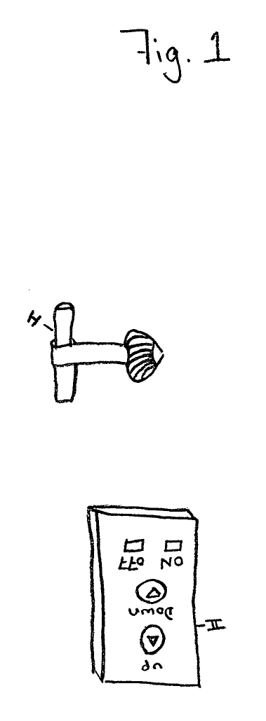

FIG. 1 is a drawing of the; R/C and manual control for the stabilizer mechanism.

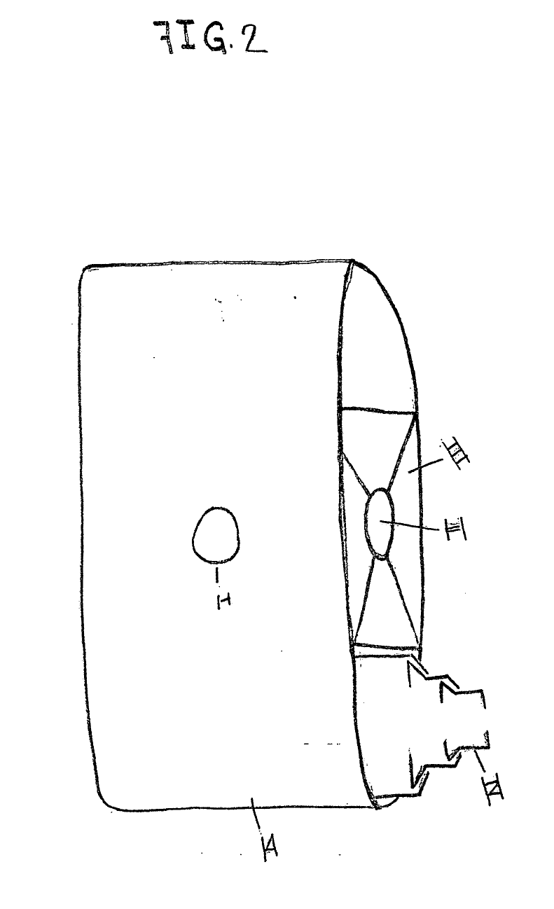

FIG. 2 is a drawing of the; stabilizer housing mechanism with a partial extension of the stabilizer arm.

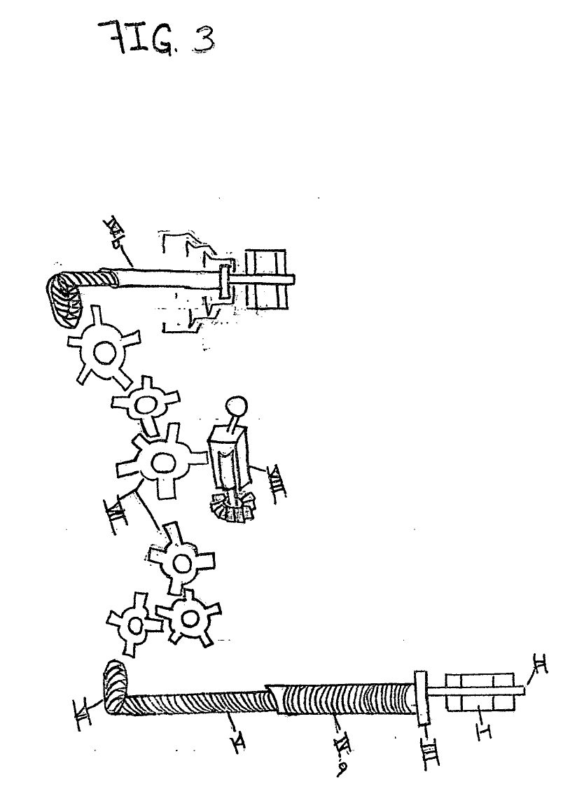

FIG. 3 is a drawing of the; inner workings of the stabilizer mechanism.

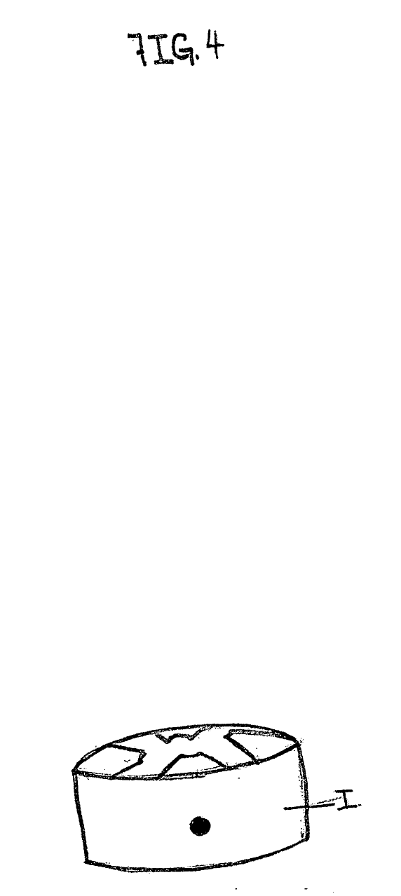

FIG. 4 is a drawing of the; stabilizer housing mechanism.

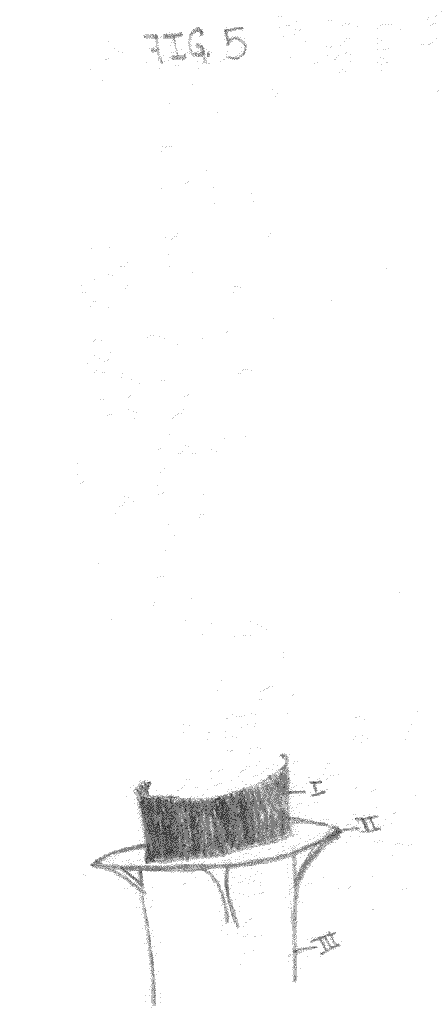

FIG. 5 is a drawing of the; outer shaft with rotational apparatus and support

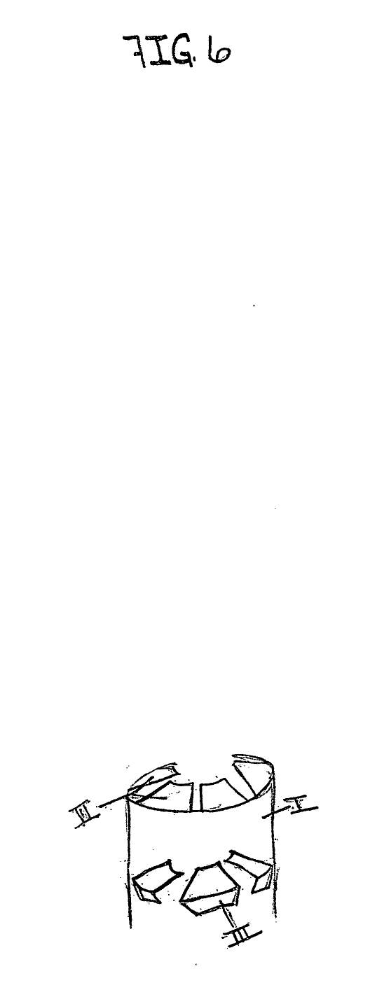

FIG. 6 is a drawing of the; inside of the outer shaft with support protrusions and outer shaft top support closures.

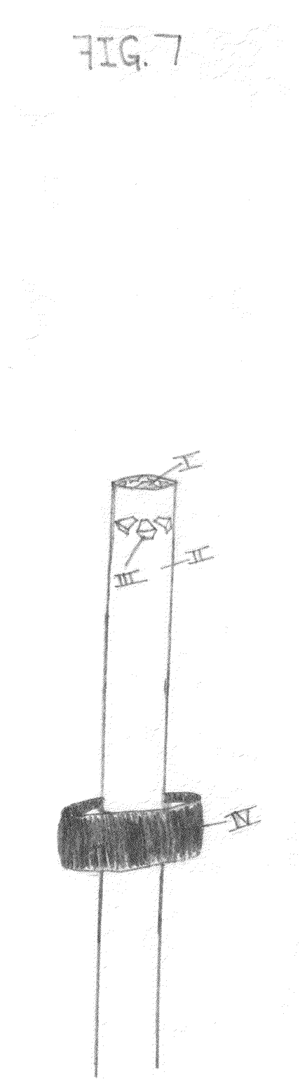

FIG. 7 is a drawing of the; middle shaft with bidirectional rotational apparatus, support protrusions and support closures.

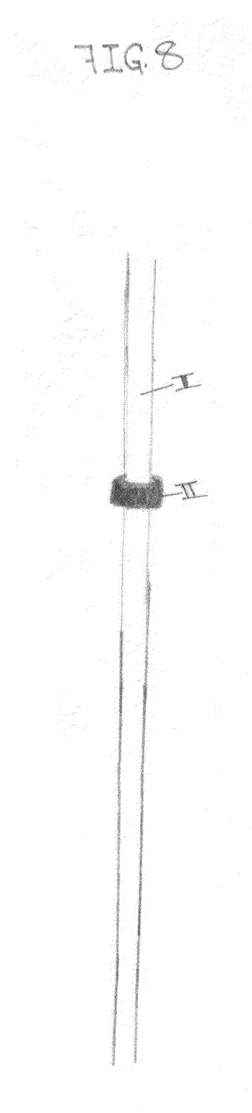

FIG. 8 is a drawing of the; inner rod with bidirectional rotational apparatus.

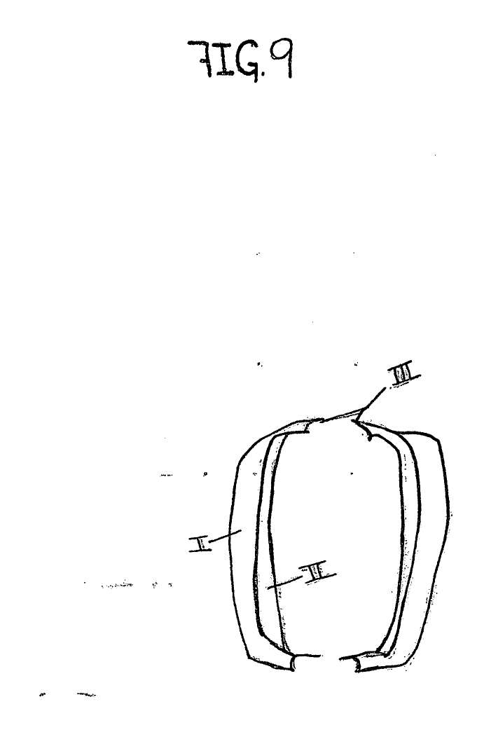

FIG. 9 is a drawing of the; inner ring of magnetic rotors.

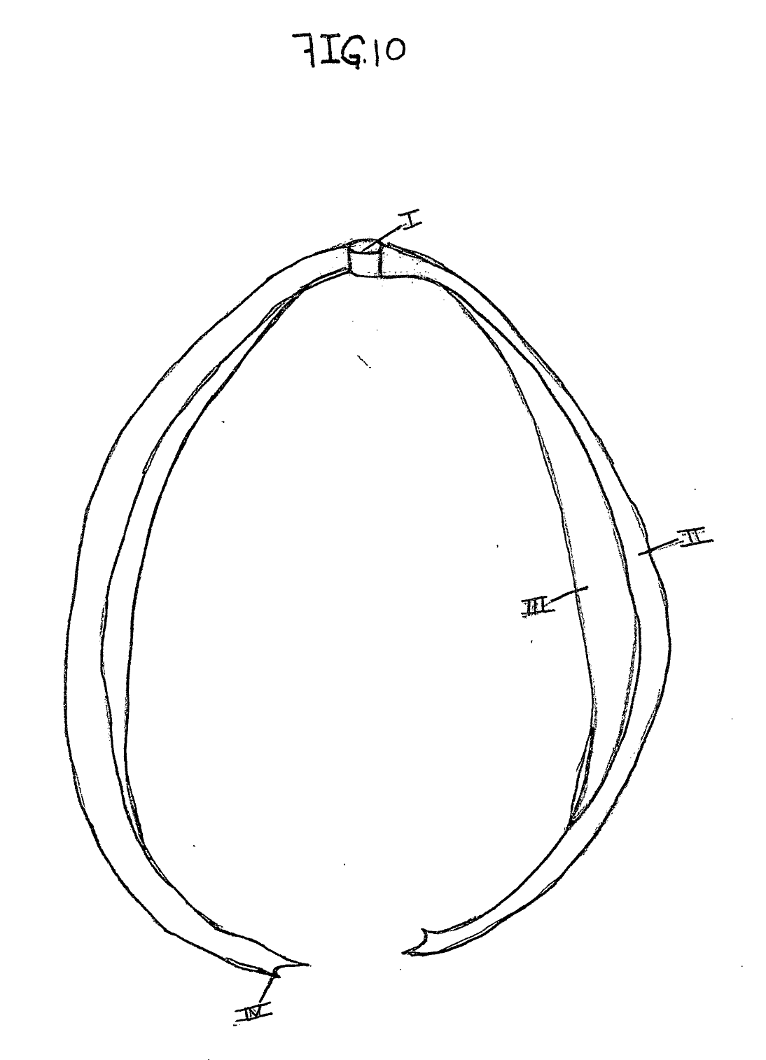

FIG. 10 is a drawing of the; outer ring of magnetic rotors.

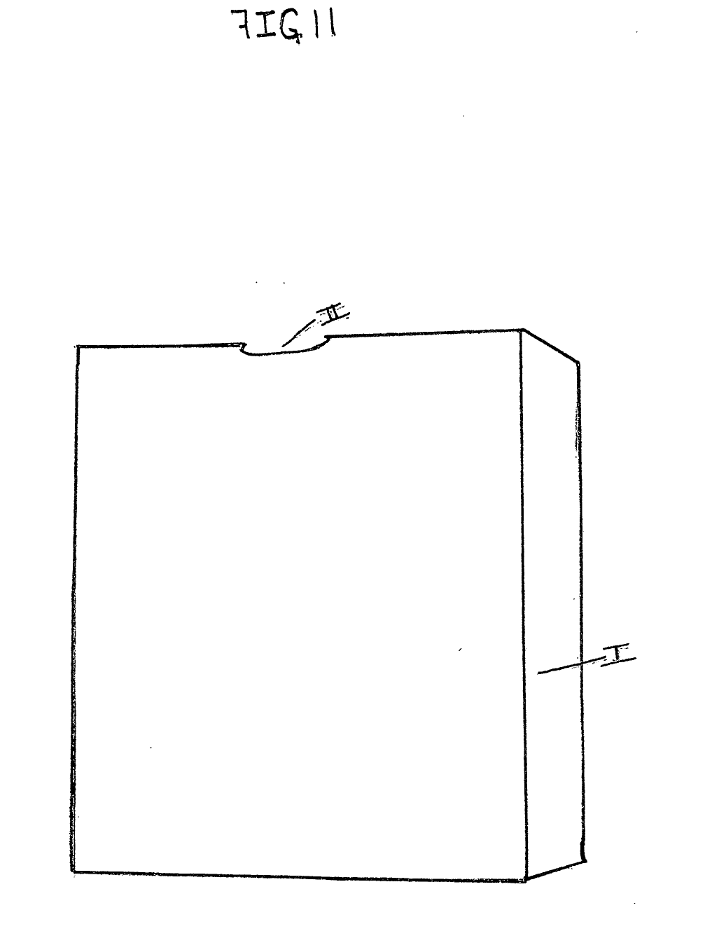

FIG. 11 is a drawing of the; electricity generator housing.

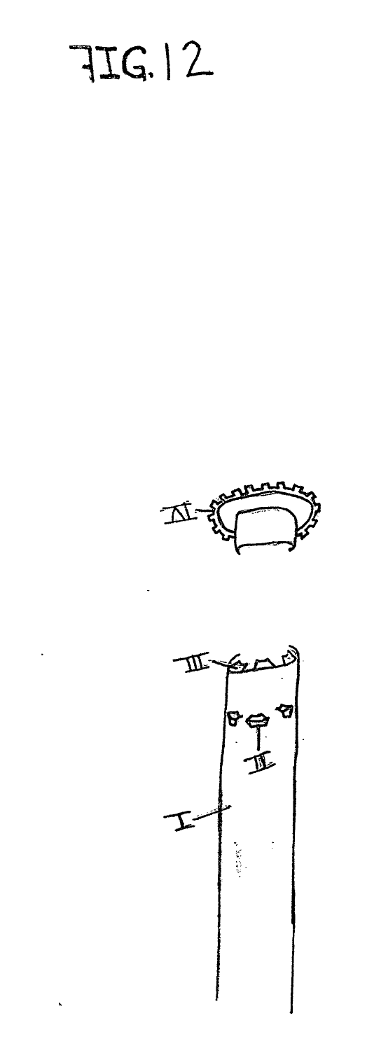

FIG. 12 is a drawing of the; inside of the outer shaft support protrusions, outer shaft support closures and middle shaft gear.

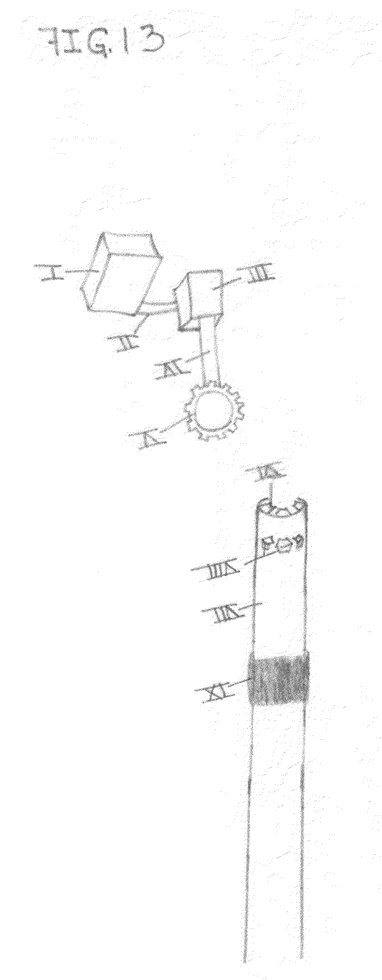

FIG. 13 is a drawing of the middle shaft's; bidirectional rotational apparatus outside, inside middle shaft support protrusions, middle shaft with support closures, generator rod gear, generator rod, generator box, a couple electricity transport wires and transformer box.

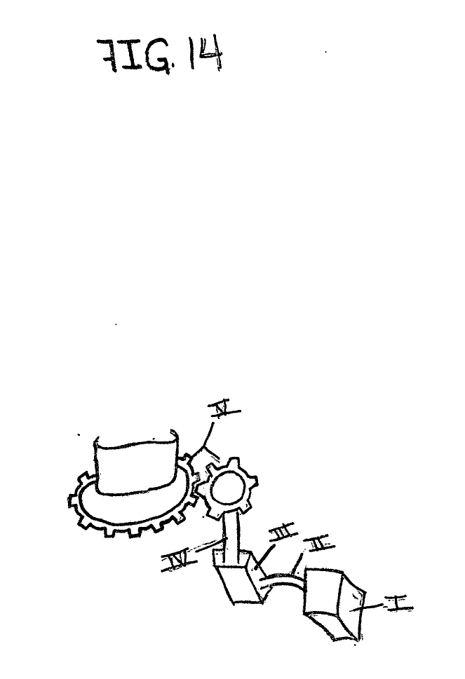

FIG. 14 is a drawing of the; outer shaft gear, generator rod gear, generator rod, generator box, a couple electricity transport wires and transformer box.

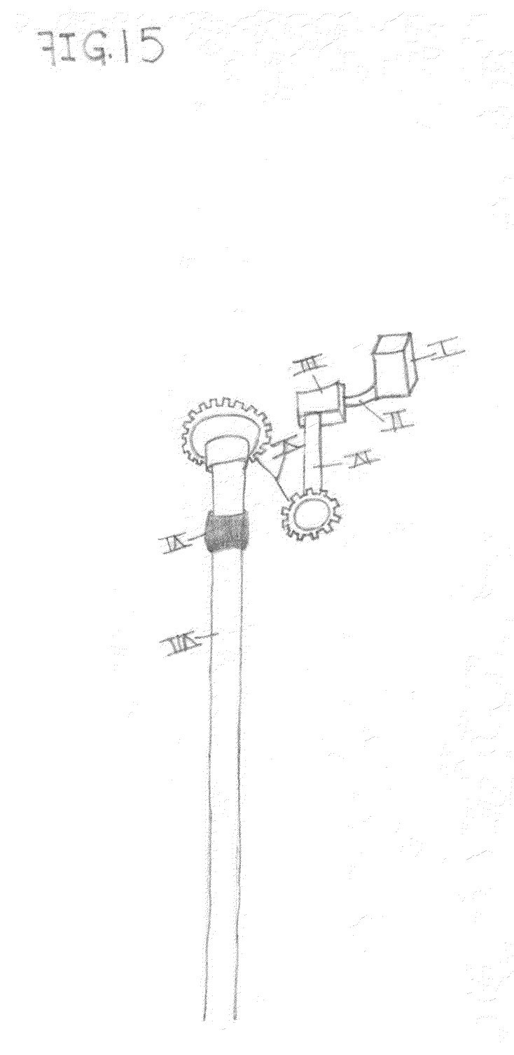

FIG. 15 is a drawing of the; inner rod, bidirectional rotational apparatus, inner rod gear, generator rod gear, generator rod, generator box, a couple electricity transport wires and transformer box.

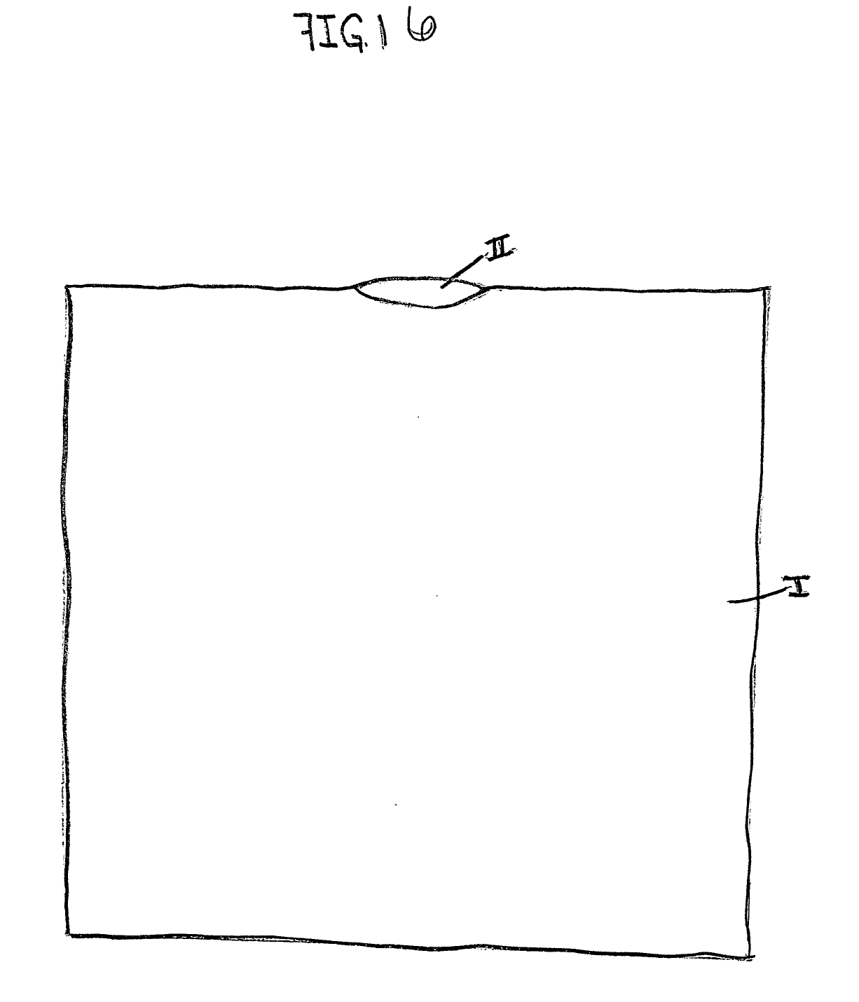

FIG. 16 is a drawing of the; electricity generator housing.

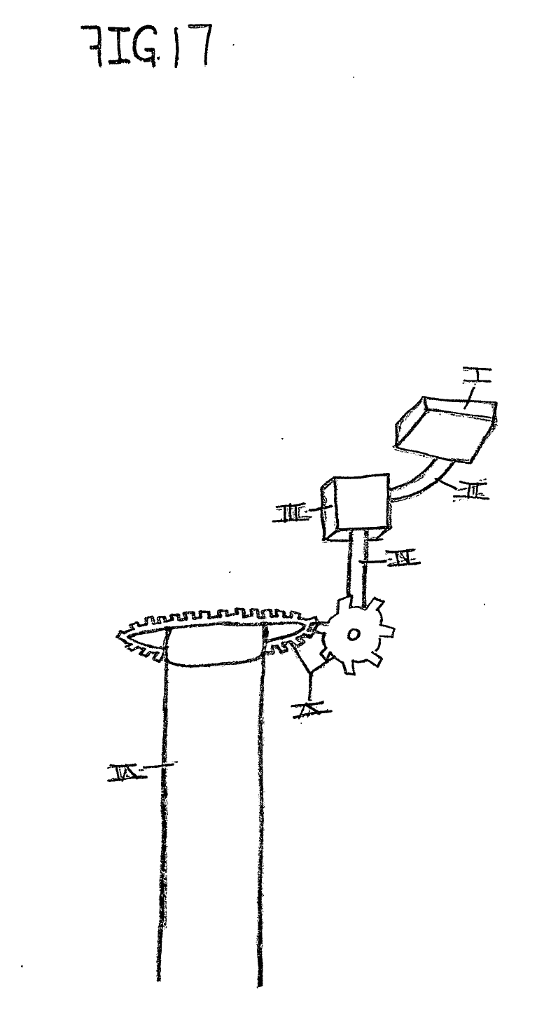

FIG. 17 is a drawing of the; outer shaft, outer shaft gear, generator rod gear, generator rod, generator box, a couple electricity transport wires and transformer box.

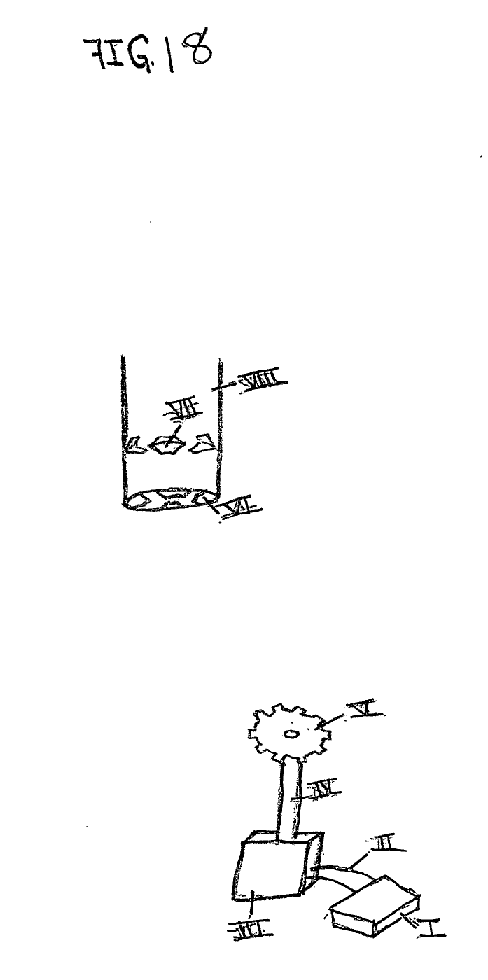

FIG. 18 is a drawing of the; outer shaft, support protrusions, support closures, generator rod gear, generator rod, generator box, a couple electricity transport wires and transformer box.

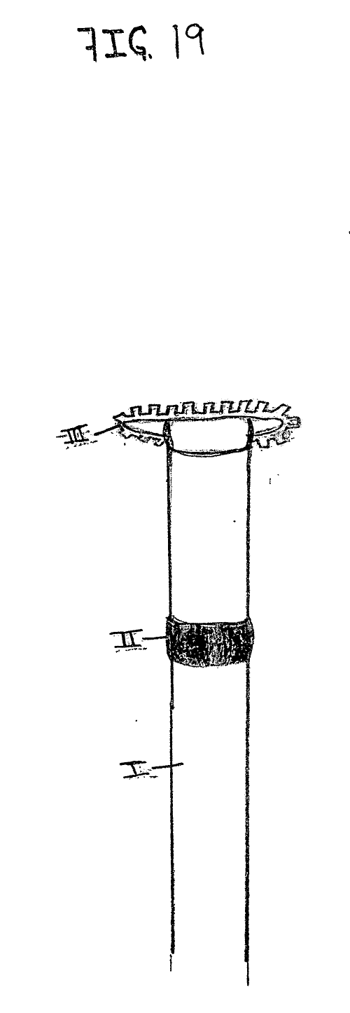

FIG. 19 is a drawing of the; inner rod with bidirectional rotational apparatus and inner rod gear.

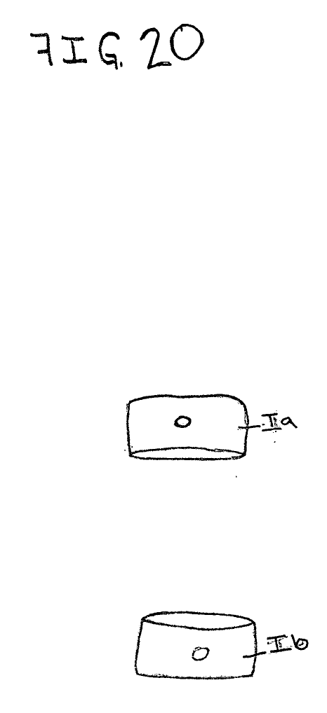

FIG. 20 is a drawing of the; two stabilizer housing mechanisms.

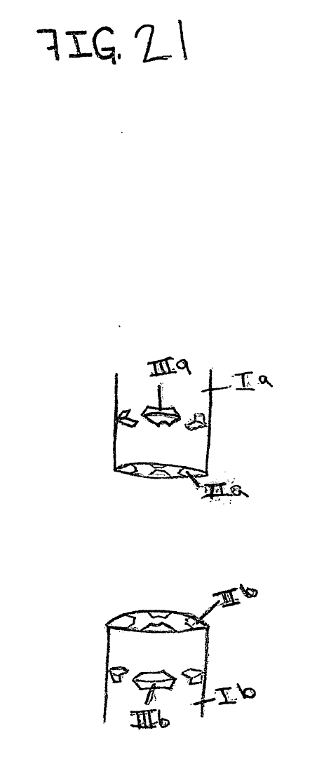

FIG. 21 is a drawing of the; inside two outer shafts, support protrusions and support closures.

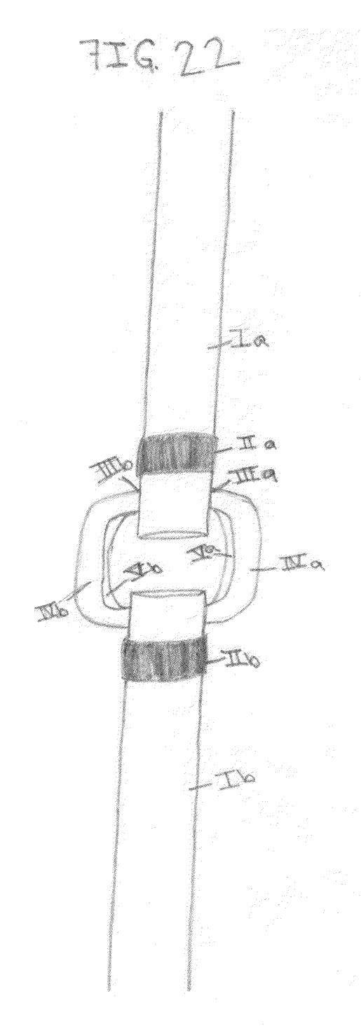

FIG. 22 is a drawing of the; two inner rods, bidirectional rotational apparatus and inner ring magnetic rotors.

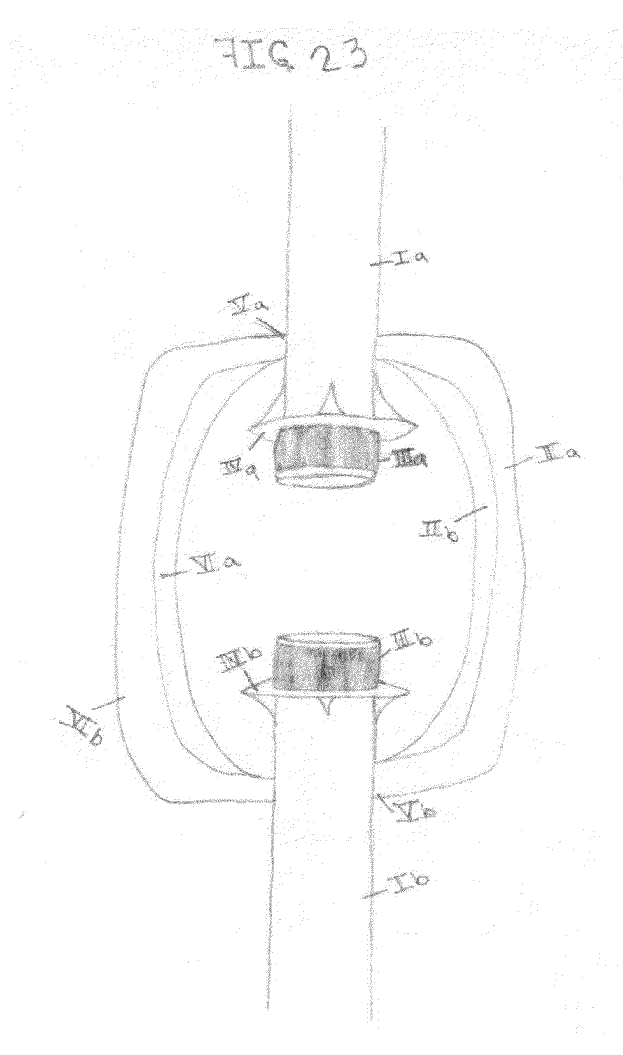

FIG. 23 is a drawing of the; two outer shafts, rotational apparatus, support ledge and outer ring magnetic rotors.

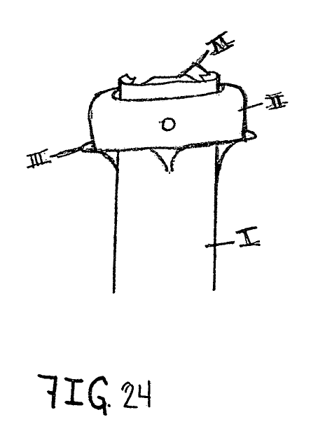

FIG. 24 is a drawing of the; outer shaft, stabilizer housing mechanism and support ledge.

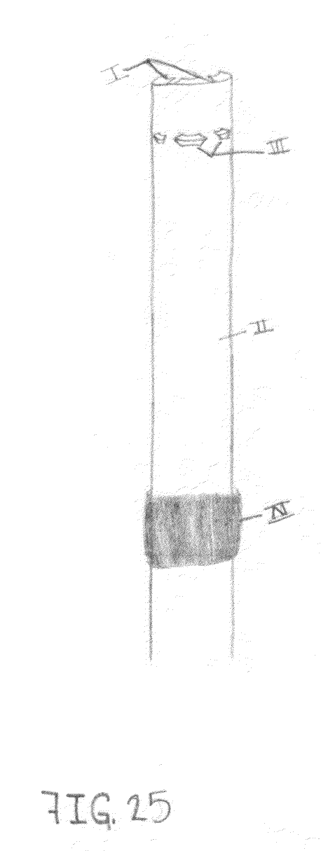

FIG. 25 is a drawing of the; middle shaft, bidirectional rotational apparatus, middle shaft support protrusions and support closures.

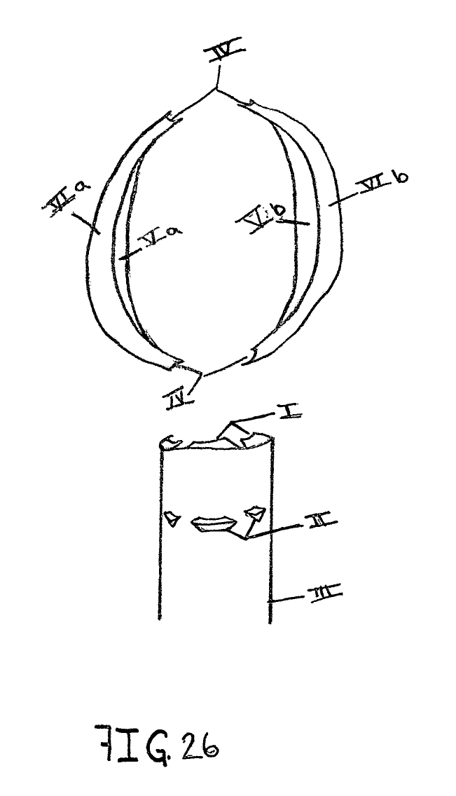

FIG. 26 is a drawing of the; outer shaft support protrusions, and support closures inner ring magnetic rotors.

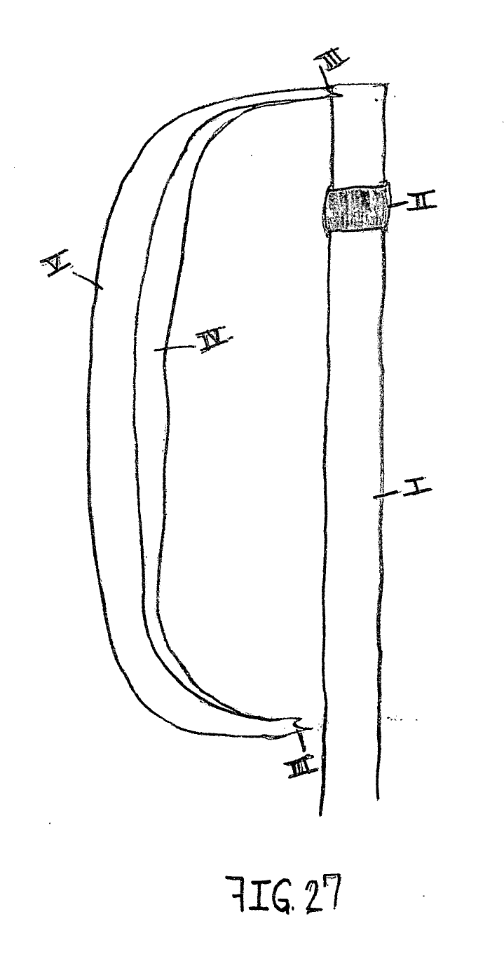

FIG. 27 is a drawing of the; inner rod, bidirectional rotational apparatus and outer magnetic rotor.

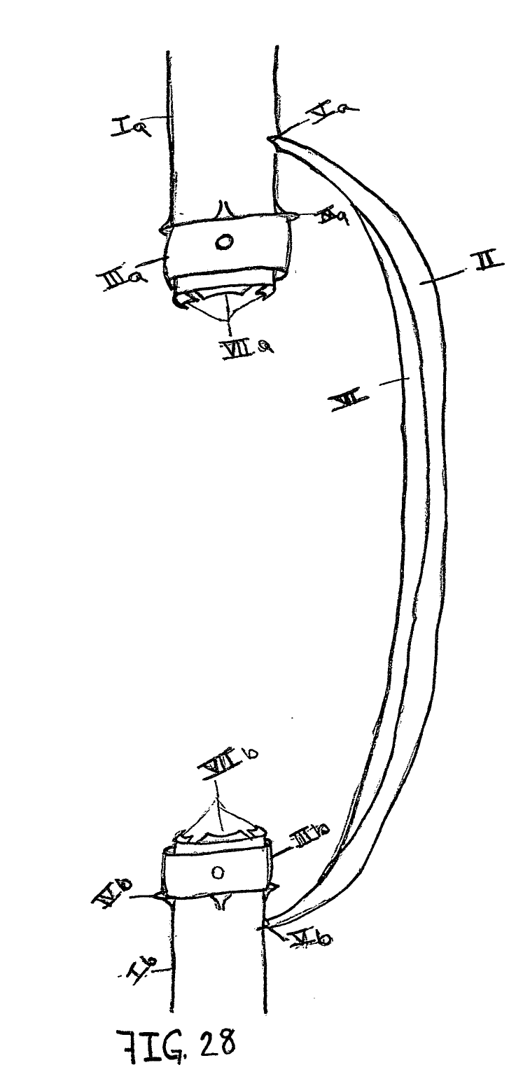

FIG. 28 is a drawing of the; outer magnetic rotor, two stabilizer housing mechanism, two outer shafts support ledges and support closures.

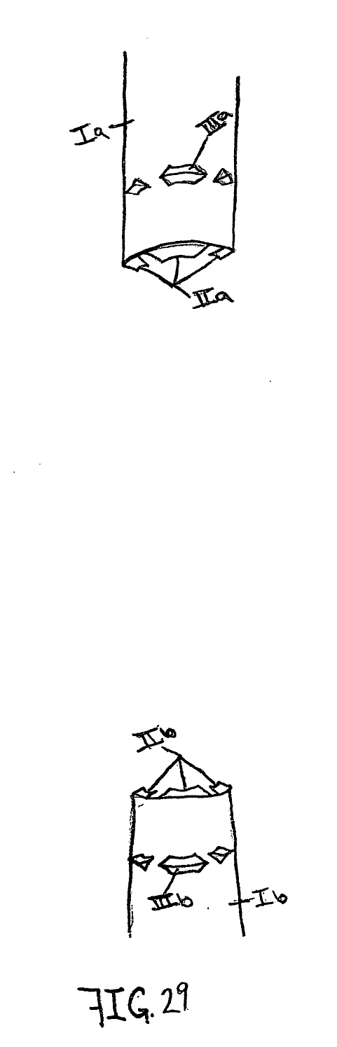

FIG. 29 is a drawing of the; two outer shafts, support protrusions and support closures.

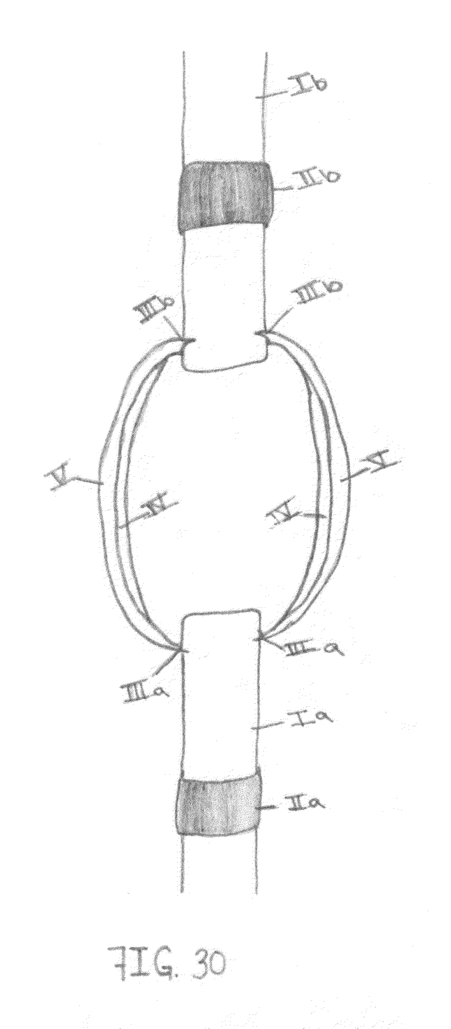

FIG. 30 is a drawing of the; inner ring magnetic rotors, two inner rods and bidirectional rotational apparatus.

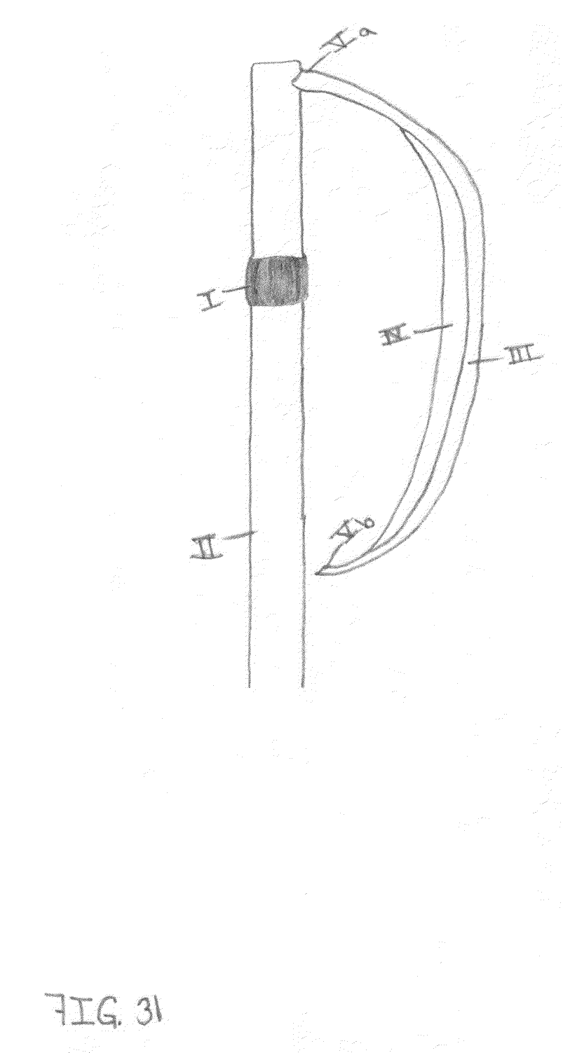

FIG. 31 is a drawing of the; outer magnetic rotor, inner rod and bidirectional rotational apparatus.

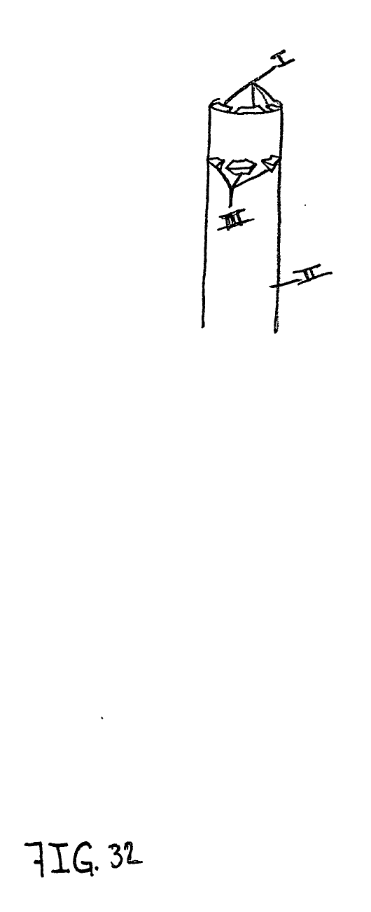

FIG. 32 is a drawing of the; middle shaft, support protrusions and support closures.

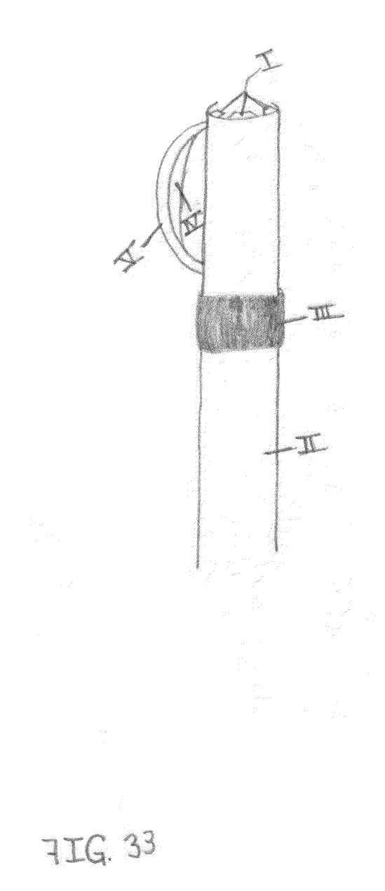

FIG. 33 is a drawing of the; middle shaft, bidirectional apparatus, inner magnetic rotor and support closures.

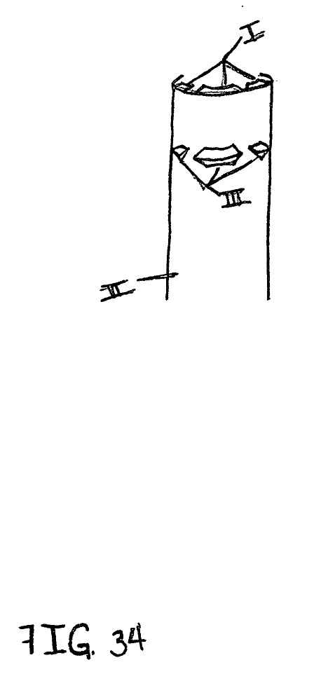

FIG. 34 is a drawing of the; outer shaft, support protrusions and support closures.

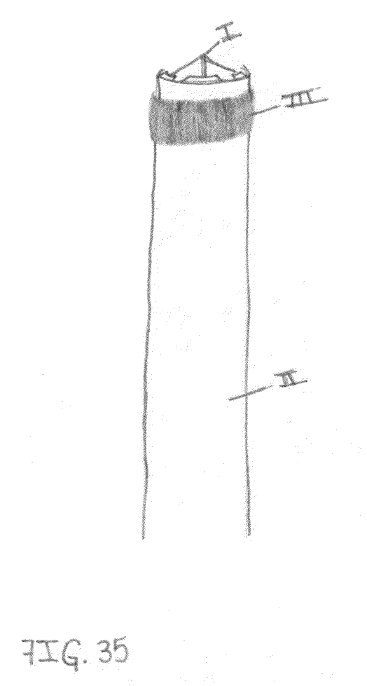

FIG. 35 is a drawing of the; outer shaft, rotational apparatus and support closures.

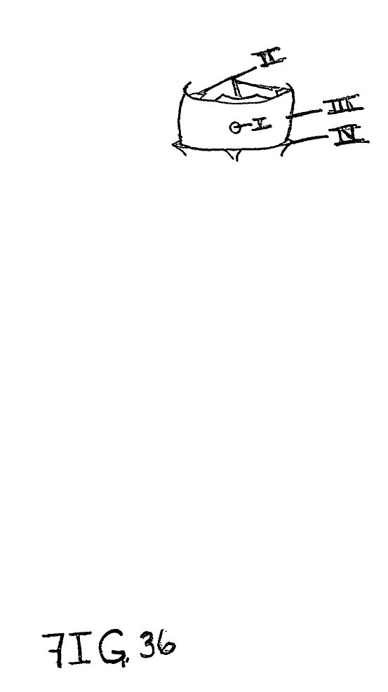

FIG. 36 is a drawing of the; stabilizer housing mechanism, support ledge and support closures.

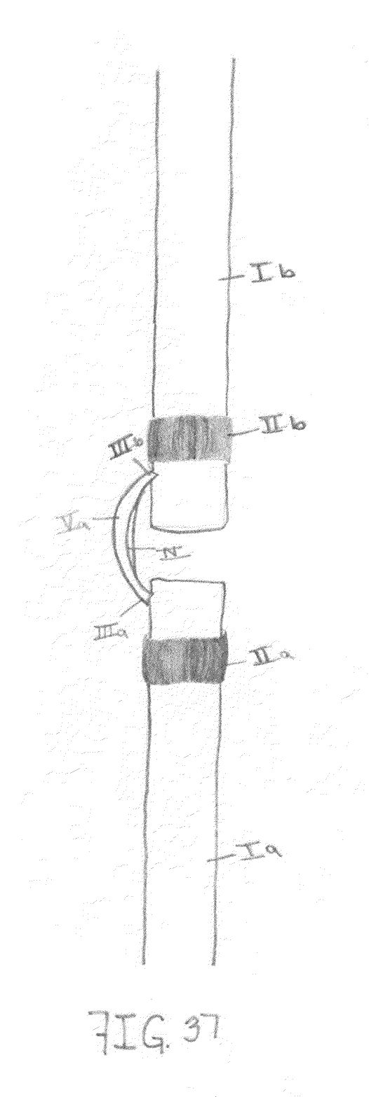

FIG. 37 is a drawing of the; two inner rods, bidirectional rotational apparatus and single inner magnetic rotor.

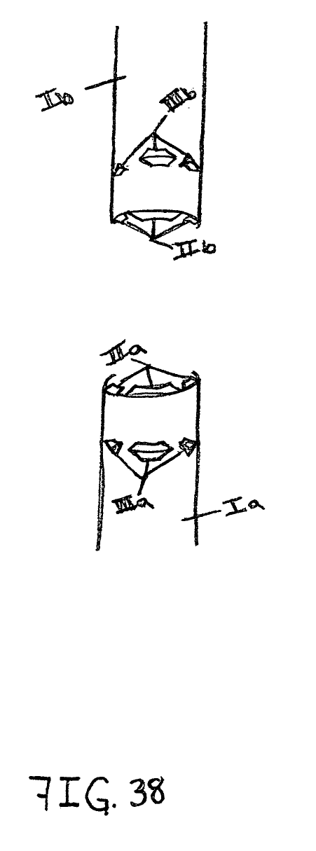

FIG. 38 is a drawing of the; two outer shafts, support protrusions and support closures.

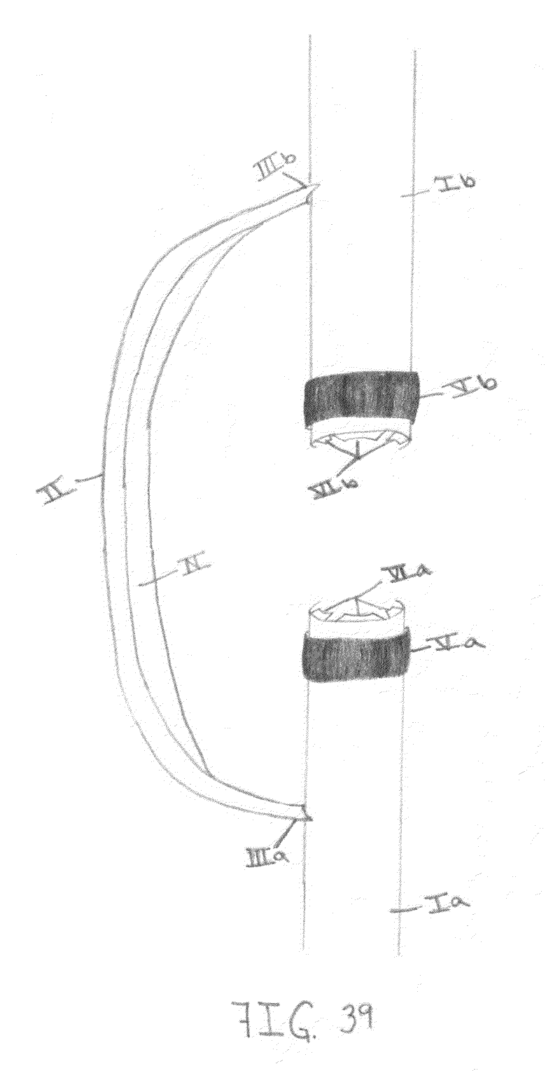

FIG. 39 is a drawing of the; two outer shafts, bidirectional rotational apparatus, single magnetic rotor support closures.

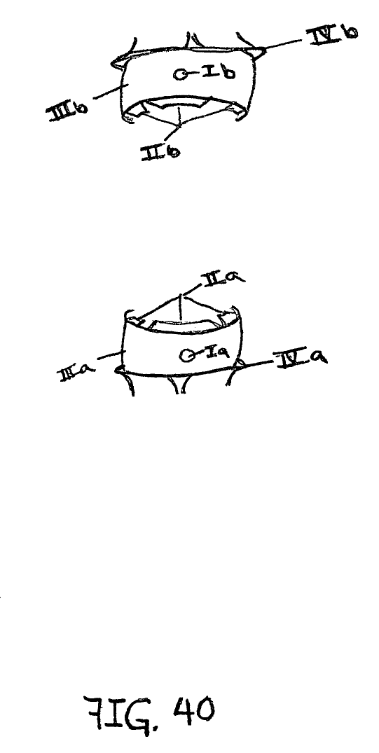

FIG. 40 is a drawing of the; two stabilizer mechanisms, support ledges and support closures.

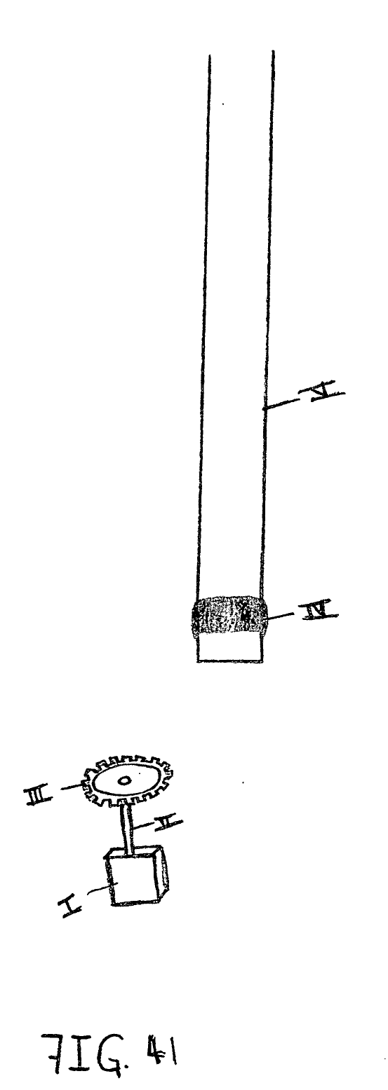

FIG. 41 is the drawing of the; inner rod, bidirectional rotational apparatus, generator rod gear, generator rod and, generator box.

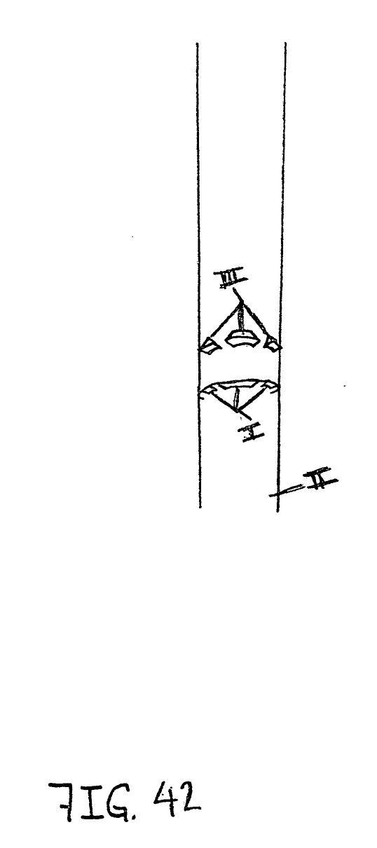

FIG. 42 is the drawing of the; middle shaft, support protrusions and support closures.

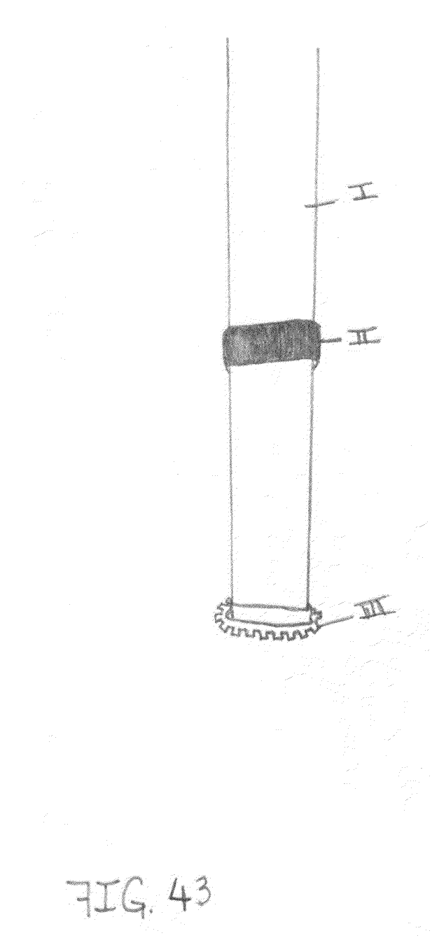

FIG. 43 is the drawing of the; middle shaft, bidirectional rotational apparatus and gear.

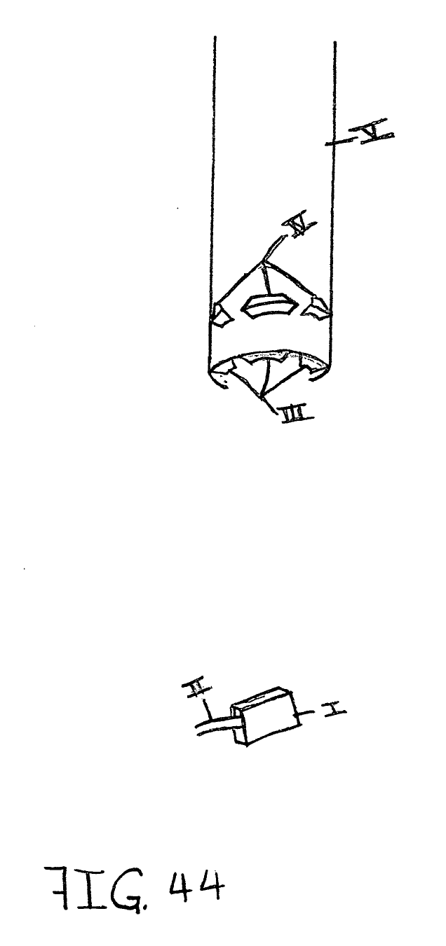

FIG. 44 is the drawing of the; outer shaft, support protrusions, support closures, a couple electricity transport wires and transformer box.

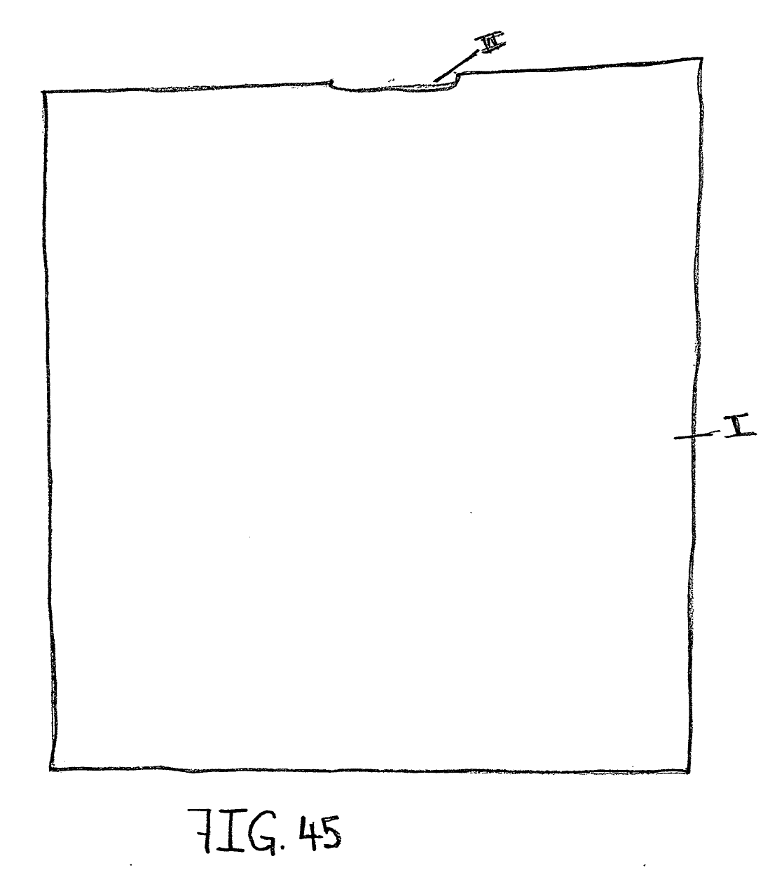

FIG. 45 is the drawing of the; electricity generator housing.

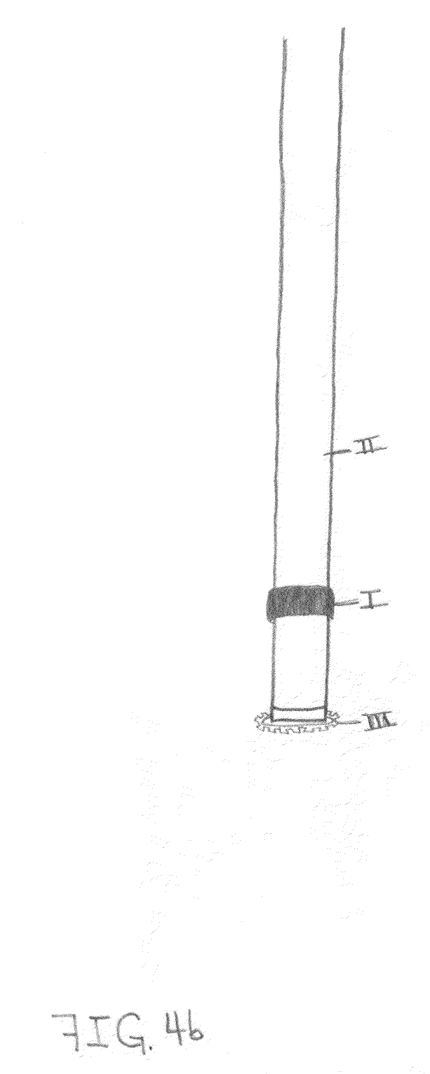

FIG. 46 is the drawing of the; inner rod, bidirectional rotational apparatus and gear.

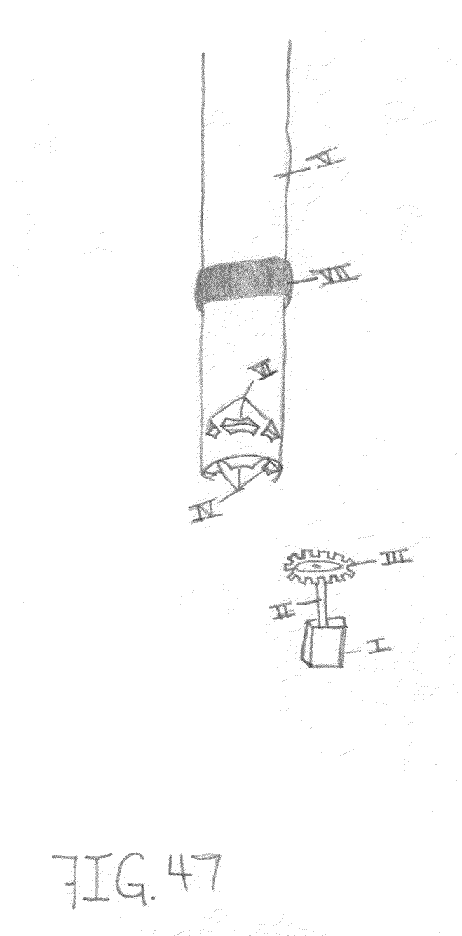

FIG. 47 is the drawing of the; middle shaft, bidirectional rotational apparatus, support protrusions, support closures, generator rod gear, generator rod and generator box.

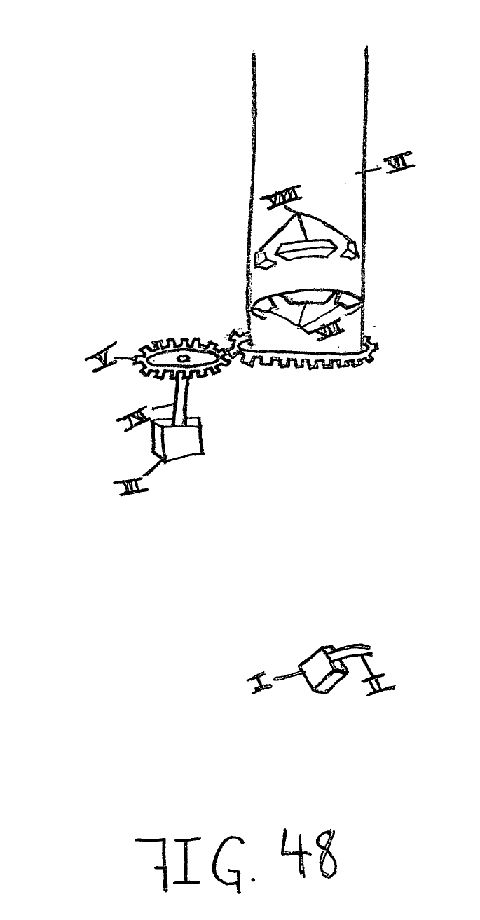

FIG. 48 is the drawing of the; outer shaft, support protrusions, outer shaft gear, generator rod gear, generator rod, generator box, a couple electricity transport wires and transformer box.

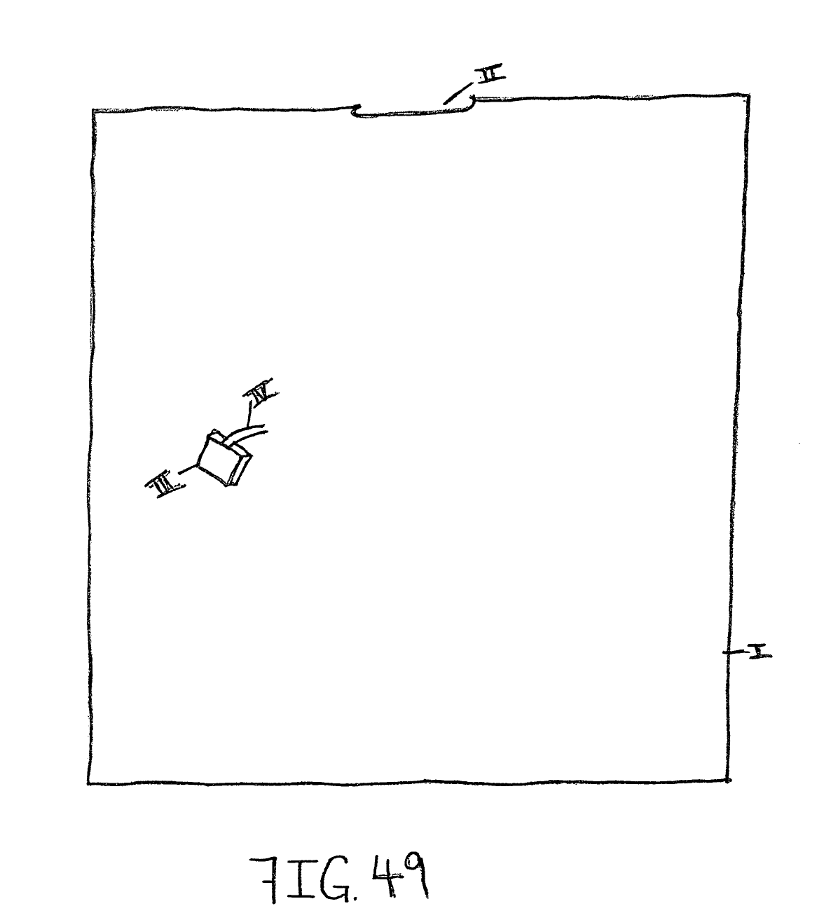

FIG. 49 is the drawing of the; electricity generator housing, a couple electricity transport wires and transformer box.

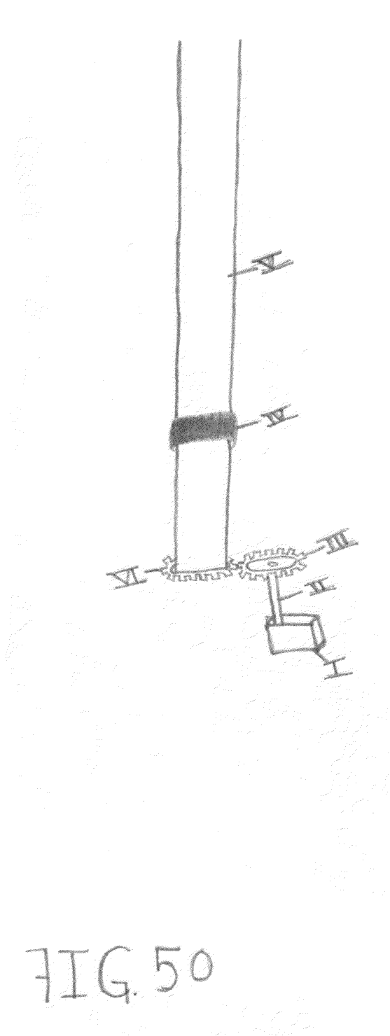

FIG. 50 is the drawing of the; inner shaft, bidirectional rotational apparatus, inner shaft gear, generator rod gear, generator rod and generator box.

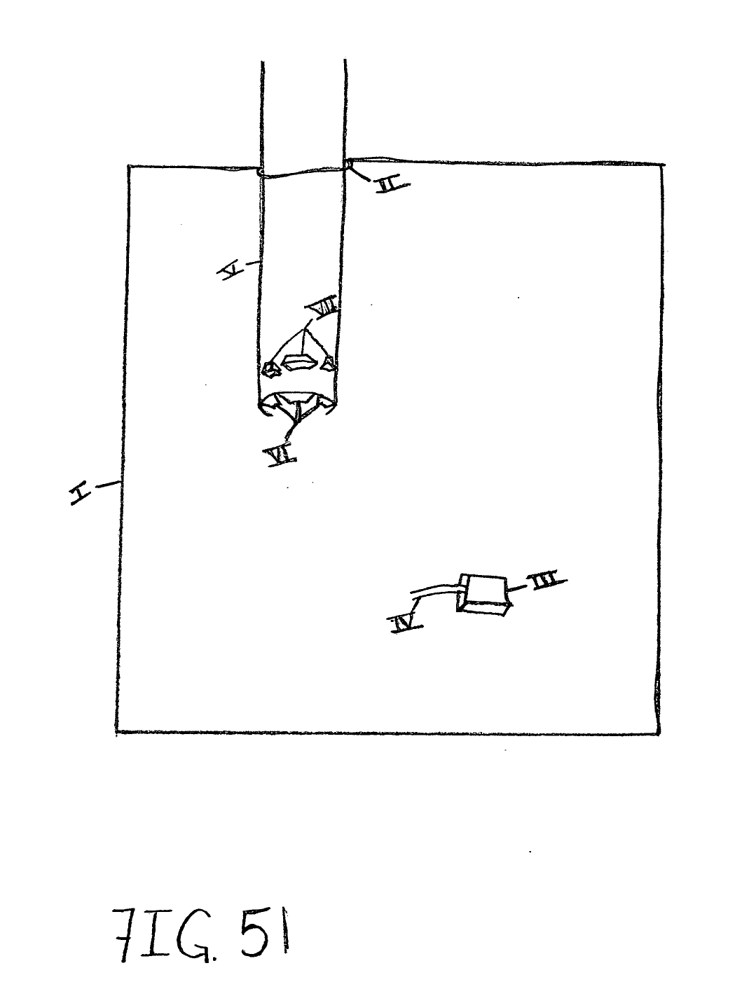

FIG. 51 is the drawing of the; outer shaft, support protrusions, support closures, electricity generator housing, a couple electricity transport wires and transformer box.

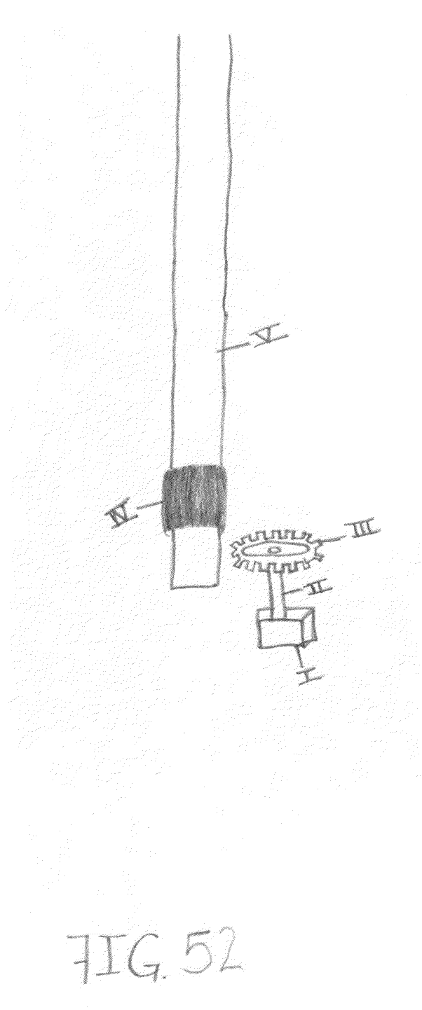

FIG. 52 is the drawing of the; inner rod, bidirectional rotational apparatus, generator rod gear, generator rod and generator box.

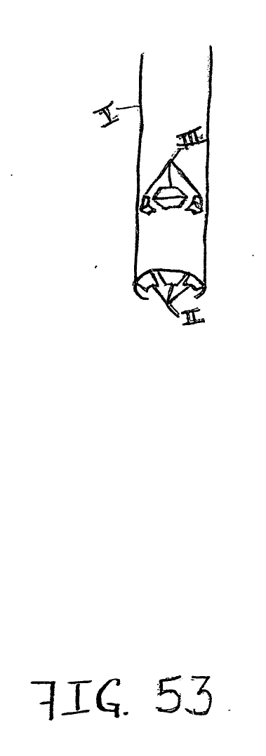

FIG. 53 is the drawing of the; outer shaft, support protrusions and support closures.

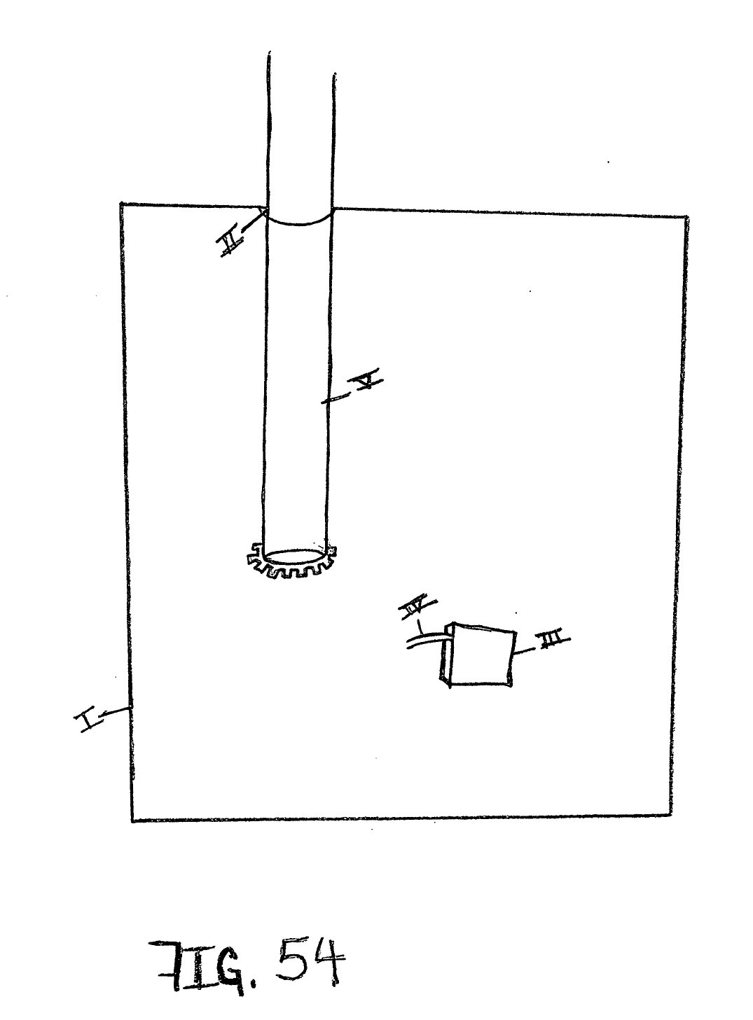

FIG. 54 is the drawing of the; outer shaft, outer shaft gear, a couple of electricity transport wires, electricity generator housing and transformer box.

### DETAILED DESCRIPTION:

Illustrations are not actual depictions of the invention or any of its components. Figures in illustrations are of both vertical and horizontal systems respectively.

Vertical embodiments are from 4-15, horizontal embodiments are from 16-23.

When viewing illustrations flatten together in sections and hold up to light.

In combination with the following embodiments and figures the invention is further described:
embodiment 1: Stabilizer operation tools: figure I; the hand held apparatus used to manually operate the stabilizer of embodiment 2, figure II; the hand held R/C (radio or remote control) apparatus used to operate the stabilizer of embodiment 2
embodiment 2: Stabilizer encasement: FIG. 1; opening for the manually operated stabilizer apparatus or the sensor for the R/C operated stabilizer, figure II; opening for the shaft and or rod system around which the stabilizer is surrounding, figure III; securing partitions which maintain the rigidity of the invention by way of prohibiting any unwanted movement of the components of embodiment 4 that allow the rod and or shafts to rotate smoothly, figure IV; telescoping sectional encasements for the telescoping arm of embodiment 3
embodiment 3: Inner components of stabilizer: figure I; permanent magnets arranged in an array with like poles facing each other, figure II; vertical slab of magnetic metal surrounded by non magnetic material which prohibits the like poles of the magnets from figure I from repelling each other, figure III; horizontal bar upon which components from figures II and I are a fixed, figure IVa; a view of a shaft threaded on the inside used to couple rotational energy from figure V for the purpose of raising and lowering the stabilizer arm, figure IVb; an outside view of a shaft threaded on the inside used to couple rotational energy from figure V for the purpose of raising and lowering the stabilizer arm, figure V; rod threaded on outside used to couple rotational energy from figure VI for the purpose of raising and lowering the stabilizer arm, figure VI; a gear used to translate rotational energy from figure VII for the purpose of raising and lowering the stabilizer arm, figure VII; gears used to translate rotational energy from figure VIII and figure I from embodiment 1 for the purpose of raising and lowering the stabilizer arm, figure VIII; a R/C motor with power supply and gear attached used to generate rotational energy and supply it to figures VII for the purpose of operating the stabilizer arm
embodiment 4: telescoping stabilizer system: figure I; a front and top view of the magnetic turbines' stabilizer system
embodiment 5: Outer shaft and components: figure I; apparatus which will allow for the smooth rotation of the shaft it is wrapped around while keeping the stabilizer system it is inside of stationary and also maintaining rigidity of the invention by prohibiting any components from any unwanted movements in any other direction other than clock wise and counter clock wise, figure II; a ledge or support systems that permit the apparatus of figure I which allows for smooth rotation to remain stationary it is also where the stabilizer will be secured in its stationary position around figure III, figure III; the outer shaft
embodiment 6: Inside view of Outer shaft: figure I; outer shaft, figure II; partitions that secure the apparatus of figure IV of embodiment 7 by maintaining the rigidity of the invention and prohibiting any unwanted movements of the invention and the partitions also allow for a rod and or shaft to pass through, figure III; ledges or a support systems that secure the apparatus of figure IV of embodiment 7 by maintaining the rigidity of the invention and prohibiting any unwanted movements of the invention these ledges or support systems also allow for a rod or shaft to pass through
embodiment 7: Inside and outside view of the middle shaft and components: figure I; partitions that secure the apparatus of figure II of embodiment 8 by maintaining the rigidity of the invention and prohibiting any unwanted movements of any other components of the invention they also allow for a rod or shaft to pass through, figure II; the middle shaft, figure III; inside view of the middle shaft showing ledges or support systems that secure the apparatus of figure II of embodiment 8 by maintaining the rigidity of the invention and prohibiting any unwanted movements of the invention these ledges or support systems also allow for a rod or shaft to pass through, figure IV; apparatus which will allow for the smooth simultaneous rotation of both the shaft and or rod it is wrapped around and inside of while maintaining rigidity of the invention by prohibiting any components from any unwanted movements in any other direction other than clock wise and counter clock wise
embodiment 8: Inner rod and components: figure I; outside view of the inner rod, figure II; apparatus which will allow for the smooth simultaneous rotation of both the shaft and or rod it is wrapped around and inside of while maintaining rigidity of the invention by prohibiting any components from any unwanted movements in any other direction other than clock wise and counter clock wise
embodiment 9: Inner ring rotors: figure I; magnetic material portion of the inner magnetic and non magnetic rotor system with polarized side facing outwardly for the purpose of repulsion by a like magnetic pole from figure III of embodiment 10 to generate rotational energy, figure II; non magnetic material portion of the inner magnetic and non magnetic rotor system, figure III; points of attachments to the middle shaft which causes the shaft to rotate from the repulsive force of the like poles of the magnets on the rotor systems
embodiment 10: Outer ring rotors: figure I; point of attachment to the inner rod which causes the rod to rotate from the repulsive force of the like poles of the magnets on the rotor systems, figure II; non magnetic material portion of the outer magnetic and non magnetic rotor system, figure III; magnetic material portion of the outer magnetic and non magnetic rotor system with polarized side facing outwardly for the purpose of repulsion by a like magnetic pole from figure II of embodiment 9 to generate rotational energy, figure IV; points of attachments to the outer shaft which causes the shaft to rotate from the repulsive force of the like poles of the magnets on the rotor systems
embodiment 11: Electricity Generator Encasement: figure I; non magnetic material encasement which houses rotational energy couplings rotational energy translators generator boxes with thermo coupling and transformer boxes with thermo coupling, figure II; opening which allows for rod and shaft systems to pass through
embodiment 12: Inside view of outer shaft with components: figure I; inside view of the outer shaft that is arranged inside of the non magnetic encasement of figure I of embodiment 11, figure II; inside view of the outer shaft showing ledges or support systems that secure the apparatus of figure IX of embodiment 13 by maintaining the rigidity of the invention and prohibiting any unwanted movements of the invention these ledges or support systems also allow for a rod or shaft to pass through, figure III; partitions that secure the apparatus of figure IX of embodiment 13 by maintaining the rigidity of the invention and prohibiting any unwanted movements of any other components of the invention they also allow for a rod or shaft to pass through, figure IV; a gear used to translate the rotational energy of the middle shaft of figure VII of embodiment 13 as it would be housed inside of the non magnetic encasement of figure I of embodiment 11
embodiment 13: Inside and outside view of middle shaft with components: figure I; transformer box with thermo coupling lining, figure II; electrical energy transference component, figure III; generator box with thermo coupling lining, figure IV; rotational energy translation rod or electrical energy generator rod or generator box rod, figure V; rotational energy coupling gear or electrical energy generator rod gear, figure VI; partitions that secure the apparatus of figure VI of embodiment 15 by maintaining the rigidity of the invention and prohibiting any unwanted movements of any other components of the invention they also allow for a rod to pass through, figure VII; the outside and inside view of the middle shaft, figure VIII; inside view of the middle shaft showing ledges or support systems that secure the apparatus of figure VI of embodiment 15 by maintaining the rigidity of the invention and prohibiting any unwanted movements of the invention these ledges or support systems also allow for a rod to pass through, figure IX; apparatus which will allow for the smooth simultaneous rotation of both the shaft it is wrapped around and the shaft it is inside of while maintaining rigidity of the invention by prohibiting any components from any unwanted movements in any other direction other than clock wise and counter clock wise as it would be housed inside of the non magnetic encasement of figure I of embodiment 11
embodiment 14: Electrical energy generators and rotational energy translators: figure I; transformer box with thermo coupling lining, figure II; electrical energy transference component, figure III; generator box with thermo coupling lining, figure IV; rotational energy translation rod or electrical energy generator rod or generator box rod, figure V; rotational energy coupling gears or electrical energy generator rod gear and outer shaft rotational energy translator gear as it would be housed inside of the non magnetic encasement of figure I of embodiment 11
embodiment 15: Inner rod and components: figure I; transformer box with thermo coupling lining, figure II; electrical energy transference component, figure III; generator box with thermo coupling lining, figure IV; rotational energy translation rod or electrical energy generator rod or generator box rod, figure V; rotational energy coupling gears or electrical energy generator rod gear and inner rod rotational energy translator gear, figure VI; apparatus which will allow for the smooth simultaneous rotation of both the rod it is wrapped around and the shaft it is inside of while maintaining rigidity of the invention by prohibiting any components from any unwanted movements in any other direction other than clock wise and counter clock wise, figure VII; outside view of the inner rod as it would be housed inside of the non magnetic encasement of figure I of embodiment 11
embodiment 16: Electricity Generator Encasement: figure I; non magnetic material encasement which houses rotational energy couplings rotational energy translators generator boxes with thermo coupling and transformer boxes with thermo coupling, figure II; opening which allows for rod and shaft systems to pass through
embodiment 17: Outside view of outer shaft with components: figure I; transformer box with thermo coupling lining, figure II; electrical energy transference component, figure III; generator box with thermo coupling lining, figure IV; rotational energy translation rod or electrical energy generator rod or generator box rod, figure V; rotational energy coupling gears or electrical energy generator rod gear and outer shaft rotational energy translator gear, figure VI; outside view of the outer shaft as it would be housed inside of the non magnetic encasement of figure I of embodiment 16
embodiment 18: Inside view of outer shaft and components: figure I; transformer box with thermo coupling lining, figure II; electrical energy transference component, figure III; generator box with thermo coupling lining, figure IV; rotational energy translation rod or electrical energy generator rod or generator box rod, figure V; rotational energy coupling gear or electrical energy generator rod gear, figure VI; partitions that secure the apparatus of figure II of embodiment 19 by maintaining the rigidity of the invention and prohibiting any unwanted movements of any other components of the invention they also allow for a rod and or shaft to pass through, figure VII; inside view of the outer shaft showing ledges or support systems that secure the apparatus of figure II of embodiment 19 by maintaining the rigidity of the invention and prohibiting any unwanted movements of the invention these ledges or support systems also allow for a rod and or shaft to pass through as it would be housed inside of the non magnetic encasement of figure I of embodiment 16
embodiment 19: outside view of middle shaft: figure I; the outside view of the middle shaft, figure II; apparatus which will allow for the smooth simultaneous rotation of both the shaft it is wrapped around and the shaft it is inside of while maintaining rigidity of the invention by prohibiting any components from any unwanted movements in any other direction other than clock wise and counter clock wise, figure III; rotational energy coupling gear or middle shaft rotational energy translator gear as it would be housed inside of the non magnetic encasement of figure I of embodiment 16
embodiment 20: Telescoping stabilizer system: figure Ia; a front and top view of the magnetic turbines' stabilizer system, figure Ib; a front and top view of the magnetic turbines' stabilizer system
embodiment 21: Inside view of outer shafts: figure Ia; the inside view of the outer shaft, figure IIa; partitions that secure the apparatus of figure IIa of embodiment 22 by maintaining the rigidity of the invention and prohibiting any unwanted movements of any other components of the invention, figure IIIa; inside view of the outer shaft showing ledges or support systems that secure the apparatus of figure IIa of embodiment 22 by maintaining the rigidity of the invention and prohibiting any unwanted movements of the invention, figure Ib; the inside view of the outer shaft, figure IIb; partitions that secure the apparatus of figure IIb of embodiment 22 by maintaining the rigidity of the invention and prohibiting any unwanted movements of any other components of the invention, figure IIIb; inside view of the outer shaft showing ledges or support systems that secure the apparatus of figure IIb of embodiment 22 by maintaining the rigidity of the invention and prohibiting any unwanted movements of the invention
embodiment 22: Outside view of middle shaft and rotors: Figure Ia; outside view of middle shaft, figure IIa; apparatus which will allow for the smooth simultaneous rotation of both the shaft it is wrapped around and the shaft it is inside of while maintaining rigidity of the invention by prohibiting any components from any unwanted movements in any other direction other than clock wise and counter clock wise, figure IIIa; points of attachments to the middle shaft which causes the shaft to rotate from the repulsive force of the like poles of the magnets on both the outer and inner rotor systems, figure IVa; non magnetic material portion of the inner magnetic and non magnetic rotor system, figure Va; magnetic material portion of the inner magnetic and non magnetic rotor system with polarized side facing outwardly for the purpose of repulsion by a like magnetic pole from figure IIb of embodiment 23 to generate rotational energy, figure Ib; outside view of middle shaft, figure IIb; apparatus which will allow for the smooth simultaneous rotation of both the shaft it is wrapped around and the shaft it is inside of while maintaining rigidity of the invention by prohibiting any components from any unwanted movements in any other direction other than clock wise and counter clock wise, figure IIIb; points of attachments to the middle shaft which causes the shaft to rotate from the repulsive force of the like poles of the magnets on both the outer and inner rotor systems, figure IVb; non magnetic material portion of the inner magnetic and non magnetic rotor system, figure Vb; magnetic material portion of the inner magnetic and non magnetic rotor system with polarized side facing outwardly for the purpose of repulsion by a like magnetic pole from figure IIb of embodiment 23 to generate rotational energy,
embodiment 23: Outer shaft and rotor systems: figure Ia; outside view of the outer shaft, figure IIa; non magnetic material portion of the outer magnetic and non magnetic rotor system, figure IIIa; telescoping stabilizer system, figure IVa; a ledge or support systems which permits the telescoping stabilizer system to remain stationary it is also where the stabilizer will be secured in its stationary position figure Va; point of attachment to the outer shaft which causes the shaft to rotate from the repulsive force of the like poles of the magnets on both the inner and outer rotor systems, figure VIa; magnetic material portion of the outer magnetic and non magnetic rotor system with polarized side facing outwardly for the purpose of repulsion by a like magnetic pole from figure IV a&b of embodiment 22 to generate rotational energy, figure Ib; outside view of the outer shaft, figure IIb; magnetic material portion of the outer magnetic and non magnetic rotor system with polarized side facing outwardly for the purpose of repulsion by a like magnetic pole from figure IV a&b of embodiment 22 to generate rotational energy, figure IIIb; telescoping stabilizer system, figure IVb; a ledge or support systems which permits the telescoping stabilizer system to remain stationary it is also where the stabilizer will be secured in its stationary position, figure Vb; point of attachment to the outer shaft which causes the shaft to rotate from the repulsive force of the like poles of the magnets on both the inner and outer rotor systems, figure VIb; non magnetic material portion of the outer magnetic and non magnetic rotor system
embodiment 24: Outer shaft and Stabilizer system: figure I; outside view of the outer shaft, figure II; telescoping stabilizer system, figure III; a ledge or support systems which permits the telescoping stabilizer system to remain stationary it is also where the stabilizer will be secured in its stationary position, figure IV; partitions that secure the apparatus of figure IV of embodiment 25 by maintaining the rigidity of the invention and prohibiting any unwanted movements of any other components of the invention they also allow for a rod and or shaft to pass through
embodiment 25: Inside and outside view of middle shaft with components: figure I; partitions that secure the apparatus of figure II of embodiment 27 by maintaining the rigidity of the invention and prohibiting any unwanted movements of any other components of the invention they also allow for a rod and or shaft to pass through, figure II; the outside and inside view of the middle shaft, figure III; inside view of the middle shaft showing ledges or support systems that secure the apparatus of figure II of embodiment 27 by maintaining the rigidity of the invention and prohibiting any unwanted movements of the invention these ledges or support systems also allow for a rod to pass through, figure IV; apparatus which will allow for the smooth simultaneous rotation of both the shaft it is wrapped around and the shaft it is inside of while maintaining rigidity of the invention by prohibiting any components from any unwanted movements in any other direction other than clock wise and counter clock wise
embodiment 26: Inside view of outer shaft and rotor systems: figure I; partitions that secure the apparatus of figure IV of embodiment 25 by maintaining the rigidity of the invention and prohibiting any unwanted movements of any other components of the invention they also allow for a rod and or shaft to pass through, figure II; a ledge or support systems that secures the apparatus of figure IV of embodiment 25 by maintaining the rigidity of the invention and prohibiting any unwanted movements of the invention these ledges or support systems also allow for a rod and or shaft to pass through, figure III; inside view of the outer shaft, figure IV; point of attachment to the outer shaft which causes the shaft to rotate from the repulsive force of the like poles of the magnets on both the inner and outer rotor systems, figure Va; non magnetic material portion of the inner magnetic and non magnetic rotor system, figure VIa; magnetic material portion of the inner magnetic and non magnetic rotor system with polarized side facing outwardly for the purpose of repulsion by a like magnetic pole from figure IV of embodiment 27 to generate rotational energy, figure Vb; non magnetic material portion of the inner magnetic and non magnetic rotor system, figure VIb; magnetic material portion of the inner magnetic and non magnetic rotor system with polarized side facing outwardly for the purpose of repulsion by a like magnetic pole from figure IV of embodiment 27 to generate rotational energy,
embodiment 27: Inner rod and rotor system: figure I; outside view of the inner rod, figure II; apparatus which will allow for the smooth simultaneous rotation of both the rod it is wrapped around and the shaft it is inside of while maintaining rigidity of the invention by prohibiting any components from any unwanted movements in any other direction other than clock wise and counter clock wise, figure III; point of attachment to the outer shaft which causes the shaft to rotate from the repulsive force of the like poles of the magnets on both the inner and outer rotor systems, figure IV; magnetic material portion of the outer magnetic and non magnetic rotor system with polarized side facing inwardly for the purpose of repulsion by a like magnetic pole from figure VI of embodiment 26 to generate rotational energy, figure V; non magnetic material portion of the outer magnetic and non magnetic rotor system,
embodiment 23: Outer shaft and rotor systems: figure Ia; outside view of the outer shaft, figure II; non magnetic material portion of the outer magnetic and non magnetic rotor system, figure IIIa; telescoping stabilizer system, figure IVa; a ledge or support systems which permits the telescoping stabilizer system to remain stationary it is also where the stabilizer will be secured in its stationary position figure Va; point of attachment to the outer shaft which causes the shaft to rotate from the repulsive force of the like poles of the magnets on both the inner and outer rotor systems, figure VI; magnetic material portion of the outer magnetic and non magnetic rotor system with polarized side facing inwardly for the purpose of repulsion by a like magnetic pole from figure IV a&b of embodiment 30 to generate rotational energy, figure VIIa; partitions that secure the apparatus of figure II of embodiment 30 by maintaining the rigidity of the invention and prohibiting any unwanted movements of any other components of the invention they also allow for a rod and or shaft to pass through figure Ib; outside view of the outer shaft, figure IIIb; telescoping stabilizer system, figure IVb; a ledge or support systems which permits the telescoping stabilizer system to remain stationary it is also where the stabilizer will be secured in its stationary position, figure Vb; point of attachment to the outer shaft which causes the shaft to rotate from the repulsive force of the like poles of the magnets on both the inner and outer rotor systems, figure VIIb; partitions that secure the apparatus of figure II of embodiment 30 by maintaining the rigidity of the invention and prohibiting any unwanted movements of any other components of the invention they also allow for a rod and or shaft to pass through
embodiment 29: Inside view of outer shafts: figure Ia; the inside view of the outer shaft, figure IIa; partitions that secure the apparatus of figure IIa of embodiment 30 by maintaining the rigidity of the invention and prohibiting any unwanted movements of any other components of the invention also allow for a rod and or shaft to pass through, figure IIIa; inside view of the outer shaft showing ledges or support systems that secure the apparatus of figure IIa of embodiment 30 by maintaining the rigidity of the invention and prohibiting any unwanted movements of the invention also allow for a rod and or shaft to pass through, figure Ib; the inside view of the outer shaft, figure IIb; partitions that secure the apparatus of figure IIb of embodiment 30 by maintaining the rigidity of the invention and prohibiting any unwanted movements of any other components of the invention also allow for a rod and or shaft to pass through, figure IIIb; inside view of the outer shaft showing ledges or support systems that secure the apparatus of figure IIb of embodiment 30 by maintaining the rigidity of the invention and prohibiting any unwanted movements of the invention also allow for a rod and or shaft to pass through
embodiment 30: Outside view of middle shaft and rotors: Figure Ia; outside view of middle shaft, figure IIa; apparatus which will allow for the smooth simultaneous rotation of both the shaft it is wrapped around and the shaft it is inside of while maintaining rigidity of the invention by prohibiting any components from any unwanted movements in any other direction other than clock wise and counter clock wise, figure IIIa; points of attachments to the middle shaft which causes the shaft to rotate from the repulsive force of the like poles of the magnets on both the outer and inner rotor systems, figure IV; non magnetic material portion of the inner magnetic and non magnetic rotor system, figure V; magnetic material portion of the inner magnetic and non magnetic rotor system with polarized side facing outwardly for the purpose of repulsion by a like magnetic pole from figure VI of embodiment 28 to generate rotational energy, figure Ib; outside view of middle shaft, figure IIb; apparatus which will allow for the smooth simultaneous rotation of both the shaft it is wrapped around and the shaft it is inside of while maintaining rigidity of the invention by prohibiting any components from any unwanted movements in any other direction other than clock wise and counter clock wise, figure IIIb; points of attachments to the middle shaft which causes the shaft to rotate from the repulsive force of the like poles of the magnets on both the outer and inner rotor systems,
embodiment 31: Inner rod and rotor system: figure I; apparatus which will allow for the smooth simultaneous rotation of both the rod it is wrapped around and the shaft it is inside of while maintaining rigidity of the invention by prohibiting any components from any unwanted movements in any other direction other than clock wise and counter clock wise, figure II; outside view of the inner rod, figure III; non magnetic material portion of the outer magnetic and non magnetic rotor system, figure IV; magnetic material portion of the outer magnetic and non magnetic rotor system with polarized side facing inwardly for the purpose of repulsion by a like magnetic pole from figure III of embodiment 33 to generate rotational energy, figure Va; point of attachment to inner rod which causes the rod to rotate from the repulsive force of the like poles of the magnets on both the outer and inner rotor systems, figure Vb; points of attachments to the middle shaft which causes the shaft to rotate from the repulsive force of the like poles of the magnets on both the outer and inner rotor systems
embodiment 32: Inside view of the middle shaft: figure I; partitions that secure the apparatus of figure I of embodiment 31 by maintaining the rigidity of the invention and prohibiting any unwanted movements of any other components of the invention they also allow for a rod and or shaft to pass through, figure II; the middle shaft, figure III; inside view of the middle shaft showing ledges or support systems that secure the apparatus of figure I of embodiment 31 by maintaining the rigidity of the invention and prohibiting any unwanted movements of the invention these ledges or support systems also allow for a rod and or shaft to pass through,
embodiment 33: Outside view of the middle shaft and rotor system: figure I; partitions that secure the apparatus of figure I of embodiment 31 by maintaining the rigidity of the invention and prohibiting any unwanted movements of any other components of the invention they also allow for a rod and or shaft to pass through, figure II; the middle shaft, figure III; apparatus which will allow for the smooth simultaneous rotation of both the shaft and or rod it is wrapped around and inside of while maintaining rigidity of the invention by prohibiting any components from any unwanted movements in any other direction other than clock wise and counter clock wise, figure IV; non magnetic material portion of the inner magnetic and non magnetic rotor system, figure V; magnetic material portion of the inner magnetic and non magnetic rotor system with polarized side facing outwardly for the purpose of repulsion by a like magnetic pole from figure IV of embodiment 31 to generate rotational energy,
embodiment 34: Inside view of the outer shaft: figure I; partitions that secure the apparatus of figure III of embodiment 33 by maintaining the rigidity of the invention and prohibiting any unwanted movements of any other components of the invention they also allow for a rod and or shaft to pass through, figure II; inside view of the outer shaft, figure III; inside view of the outer shaft showing ledges or support systems that secure the apparatus of figure III of embodiment 33 by maintaining the rigidity of the invention and prohibiting any unwanted movements of the invention these ledges or support systems also allow for a rod and or shaft to pass through,
embodiment 35: Outside view of the outer shaft: figure I; partitions that secure the apparatus of figure III of embodiment 33 by maintaining the rigidity of the invention and prohibiting any unwanted movements of any other components of the invention they also allow for a rod and or shaft to pass through, figure II; the outer shaft, figure III; apparatus which will allow for the smooth simultaneous rotation of both the shaft and or rod it is wrapped around and inside of while maintaining rigidity of the invention by prohibiting any components from any unwanted movements in any other direction other than clock wise and counter clock wise
embodiment 36: Stabilizer encasement and support system: FIG. 1; opening for the manually operated stabilizer apparatus or the sensor for the R/C operated stabilizer, figure II; securing partitions which maintain the rigidity of the invention by way of prohibiting any unwanted movement of the components that also allow the rod and or shafts to pass through, figure III; telescoping stabilizer system, figure IV; ledge or support systems which permits the telescoping stabilizer system to remain stationary it is also where the stabilizer will be secured in its stationary position
embodiment 37: Outside view of middle shaft and rotors: Figure Ia; outside view of middle shaft, figure IIa; apparatus which will allow for the smooth simultaneous rotation of both the shaft it is wrapped around and the shaft it is inside of while maintaining rigidity of the invention by prohibiting any components from any unwanted movements in any other direction other than clock wise and counter clock wise, figure IIIa; points of attachments to the middle shaft which causes the shaft to rotate from the repulsive force of the like poles of the magnets on both the outer and inner rotor systems, figure IV; non magnetic material portion of the inner magnetic and non magnetic rotor system, figure V; magnetic material portion of the inner magnetic and non magnetic rotor system with polarized side facing outwardly for the purpose of repulsion by a like magnetic pole from figure IV of embodiment 39 to generate rotational energy, figure Ib; outside view of middle shaft, figure IIb; apparatus which will allow for the smooth simultaneous rotation of both the shaft it is wrapped around and the shaft it is inside of while maintaining rigidity of the invention by prohibiting any components from any unwanted movements in any other direction other than clock wise and counter clock wise, figure IIIb; points of attachments to the middle shaft which causes the shaft to rotate from the repulsive force of the like poles of the magnets on both the outer and inner rotor systems
embodiment 38: Inside view of outer shafts: figure Ia; the inside view of the outer shaft, figure IIa; partitions that secure the apparatus of figure IIa of embodiment 37 by maintaining the rigidity of the invention and prohibiting any unwanted movements of any other components of the invention, figure IIIa; inside view of the outer shaft showing ledges or support systems that secure the apparatus of figure IIa of embodiment 37 by maintaining the rigidity of the invention and prohibiting any unwanted movements of the invention, figure Ib; the inside view of the outer shaft, figure IIb; partitions that secure the apparatus of figure IIb of embodiment 37 by maintaining the rigidity of the invention and prohibiting any unwanted movements of any other components of the invention, figure IIIb; inside view of the outer shaft showing ledges or support systems that secure the apparatus of figure IIb of embodiment 37 by maintaining the rigidity of the invention and prohibiting any unwanted movements of the invention
embodiment 39: Outer shaft and rotor systems: figure Ia; outside view of the outer shaft, figure II; non magnetic material portion of the outer magnetic and non magnetic rotor system, figure IIIa; point of attachment to the outer shaft which causes the shaft to rotate from the repulsive force of the like poles of the magnets on both the inner and outer rotor systems, figure IV; magnetic material portion of the outer magnetic and non magnetic rotor system with polarized side facing of the like poles of the magnets on both the outer and inner rotor systems, figure Va; apparatus which will allow for the smooth simultaneous rotation of both the shaft it is wrapped around and the shaft it is inside of while maintaining rigidity of the invention by prohibiting any components from any unwanted movements in any other direction other than clock wise and counter clock wise, figure VIa; partitions that secure the apparatus of figure IIa of embodiment 37 by maintaining the rigidity of the invention and prohibiting any unwanted movements of any other components of the invention they also allow for a rod and or shaft to pass through, figure Ib; outside view of outer shaft, figure IIIb; points of attachments to the outer shaft which causes the shaft to rotate from the repulsive force of the like poles of the magnets on both the outer and inner rotor systems, figure Vb; apparatus which will allow for the smooth simultaneous rotation of both the shaft it is wrapped around and the shaft it is inside of while maintaining rigidity of the invention by prohibiting any components from any unwanted movements in any other direction other than clock wise and counter clock wise, figure VIb; partitions that secure the apparatus of figure IIb of embodiment 37 by maintaining the rigidity of the invention and prohibiting any unwanted movements of any other components of the invention they also allow for a rod and or shaft to pass through
embodiment 40: Stabilizer encasement and support system: figure Ia; opening for the manually operated stabilizer apparatus or the sensor for the R/C operated stabilizer, figure IIa; securing partitions which maintain the rigidity of the invention by way of prohibiting any unwanted movement of the components that also allow the rod and or shafts to pass through, figure IIIa; telescoping stabilizer system, figure IVa; ledge or support systems which permits the telescoping stabilizer system to remain stationary it is also where the stabilizer will be secured in its stationary position, embodiment, figure Ib; opening for the manually operated stabilizer apparatus or the sensor for the R/C operated stabilizer, figure IIb; securing partitions which maintain the rigidity of the invention by way of prohibiting any unwanted movement of the components that also allow the rod and or shafts to pass through, figure IIIb; telescoping stabilizer system, figure IVb; ledge or support systems which permits the telescoping stabilizer system to remain stationary it is also where the stabilizer will be secured in its stationary position
embodiment 41: Inner rod and components: figure I; generator box with thermo coupling lining, figure II; rotational energy translation rod or electrical energy generator rod or generator box rod, figure III; rotational energy coupling gears or electrical energy generator rod gear and inner rod rotational energy translator gear, figure IV; apparatus which will allow for the smooth simultaneous rotation of both the rod it is wrapped around and the shaft it is inside of while maintaining rigidity of the invention by prohibiting any components from any unwanted movements in any other direction other than clock wise and counter clock wise, figure V; outside view of the inner rod as it would be housed inside of the non magnetic encasement of figure I of embodiment 45
embodiment 42: Inside view of the middle shaft: figure I; partitions that secure the apparatus of figure IV of embodiment 41 by maintaining the rigidity of the invention and prohibiting any unwanted movements of any other components of the invention they also allow for a rod and or shaft to pass through, figure II; the middle shaft, figure III; inside view of the middle shaft showing ledges or support systems that secure the apparatus of figure IV of embodiment 41 by maintaining the rigidity of the invention and prohibiting any unwanted movements of the invention these ledges or support systems also allow for a rod and or shaft to pass through
embodiment 43: Outside view of middle shaft with components: figure I; the outside view of the middle shaft, figure II; apparatus which will allow for the smooth simultaneous rotation of both the shaft it is wrapped around and the shaft it is inside of while maintaining rigidity of the invention by prohibiting any components from any unwanted movements in any other direction other than clock wise and counter clock wise as it would be housed inside of the non magnetic encasement of figure I of embodiment 45, figure III; rotational energy coupling gear or middle shaft rotational energy translator gear as it would be housed inside of the non magnetic encasement of figure I of embodiment 45
embodiment 44: Inside view of outer shaft and components: figure I; transformer box with thermo coupling lining, figure II; electrical energy transference component, figure III; partitions that secure the apparatus of figure II of embodiment 43 by maintaining the rigidity of the invention and prohibiting any unwanted movements of any other components of the invention they also allow for a rod and or shaft to pass through, figure IV; inside view of the outer shaft showing ledges or support systems that secure the apparatus of figure II of embodiment 43 by maintaining the rigidity of the invention and prohibiting any unwanted movements of the invention these ledges or support systems also allow for a rod and or shaft to pass through as it would be housed inside of the non magnetic encasement of figure I of embodiment 45, figure V; inside view of outer shaft
embodiment 45: Electricity Generator Encasement: figure I; non magnetic material encasement which houses rotational energy couplings rotational energy translators generator boxes with thermo coupling and transformer boxes with thermo coupling, figure II; opening which allows for rod and shaft systems to pass through
embodiment 46: Inner rod and components: figure I; apparatus which will allow for the smooth simultaneous rotation of both the rod it is wrapped around and the shaft it is inside of while maintaining rigidity of the invention by prohibiting any components from any unwanted movements in any other direction other than clock wise and counter clock wise, figure II; outside view of the inner rod as it would be housed inside of the non magnetic encasement of figure I of embodiment 49, figure III; inner rod rotational energy coupling gear or rotational energy translator gear as it would be housed inside of the non magnetic encasement of figure I of embodiment 49
embodiment 47: Inside and outside view of middle shaft with components: figure I; generator box with thermo coupling lining, figure II; rotational energy translation rod or electrical energy generator rod or generator box rod, figure III; rotational energy coupling gear or electrical energy generator rod gear, figure IV; partitions that secure the apparatus of figure I of embodiment 46 by maintaining the rigidity of the invention and prohibiting any unwanted movements of any other components of the invention they also allow for a rod and or shaft to pass through, figure V; the outside and inside view of the middle shaft, figure VI; inside view of the middle shaft showing ledges or support systems that secure the apparatus of figure I of embodiment 46 by maintaining the rigidity of the invention and prohibiting any unwanted movements of the invention these ledges or support systems also allow for a rod to pass through, figure VII; apparatus which will allow for the smooth simultaneous rotation of both the shaft it is wrapped around and the shaft it is inside of while maintaining rigidity of the invention by prohibiting any components from any unwanted movements in any other direction other than clock wise and counter clock wise as it would be housed inside of the non magnetic encasement of figure I of embodiment 49
embodiment 48: Inside and outside view of outer shaft with components: figure I; transformer box with thermo coupling lining, figure II; electrical energy transference component, figure III; generator box with thermo coupling lining, figure IV; rotational energy translation rod or electrical energy generator rod or generator box rod, figure V; rotational energy coupling gears or electrical energy generator rod gear and outer shaft rotational energy translator gear, figure VI; inside and outside view of the outer shaft as it would be housed inside of the non magnetic encasement of figure I of embodiment 49, figure VII; partitions that secure the apparatus of figure VII of embodiment 47 by maintaining the rigidity of the invention and prohibiting any unwanted movements of any other components of the invention they also allow for a rod and or shaft to pass through, figure VIII; inside view of the outer shaft showing ledges or support systems that secure the apparatus of figure VII of embodiment 47 by maintaining the rigidity of the invention and prohibiting any unwanted movements of the invention these ledges or support systems also allow for a rod and or shaft to pass through as it would be housed inside of the non magnetic encasement of figure I of embodiment 49, figure IX; rotational energy coupling gear or outer shaft rotational energy translator gear as it would be housed inside of the non magnetic encasement of figure I of embodiment 49
embodiment 49: Electricity Generator Encasement: figure I; non magnetic material encasement which houses rotational energy couplings rotational energy translators generator boxes with thermo coupling and transformer boxes with thermo coupling, figure II; opening which allows for rod and shaft systems to pass through, figure III; transformer box with thermo coupling lining, figure VI; electrical energy transference component
embodiment 50: Inner rod and components: figure I; generator box with thermo coupling lining, figure II; rotational energy translation rod or electrical energy generator rod or generator box rod, figure III; rotational energy coupling gears or electrical energy generator rod gear and inner rod rotational energy translator gear, figure IV; apparatus which will allow for the smooth simultaneous rotation of both the rod it is wrapped around and the shaft it is inside of while maintaining rigidity of the invention by prohibiting any components from any unwanted movements in any other direction other than clock wise and counter clock wise, figure V; outside view of the inner rod as it would be housed inside of the non magnetic encasement of figure I of embodiment 51, figure VI; rotational energy coupling gear or middle shaft rotational energy translator gear as it would be housed inside of the non magnetic encasement of figure I of embodiment 51
embodiment 51: Electricity Generator Encasement: figure I; non magnetic material encasement which houses rotational energy couplings rotational energy translators generator boxes with thermo coupling and transformer boxes with thermo coupling, figure II; opening which allows for rod and shaft systems to pass through, figure III; transformer box with thermo coupling lining, figure VI; electrical energy transference component, figure V; inside and outside view of the outer shaft as it would be housed inside of the non magnetic encasement of figure I of embodiment 51, figure VI; partitions that secure the apparatus of figure IV of embodiment 50 by maintaining the rigidity of the invention and prohibiting any unwanted movements of any other components of the invention they also allow for a rod and or shaft to pass through, figure VII; inside view of the outer shaft showing ledges or support systems that secure the apparatus of figure IV of embodiment 50 by maintaining the rigidity of the invention and prohibiting any unwanted movements of the invention these ledges or support systems also allow for a rod and or shaft to pass through as it would be housed inside of the non magnetic encasement of figure I of embodiment 51,
embodiment 52: Inner rod and components: figure I; generator box with thermo coupling lining, figure II; rotational energy translation rod or electrical energy generator rod or generator box rod, figure III; rotational energy coupling gears or electrical energy generator rod gear and inner rod rotational energy translator gear, figure IV; apparatus which will allow for the smooth simultaneous rotation of both the rod it is wrapped around and the shaft it is inside of while maintaining rigidity of the invention by prohibiting any components from any unwanted movements in any other direction other than clock wise and counter clock wise, figure V; outside view of the inner rod as it would be housed inside of the non magnetic encasement of figure I of embodiment 54,
embodiment 53: Inside view of outer shaft: figure I; inside view of the outer shaft as it would be housed inside of the non magnetic encasement of figure I of embodiment 54, figure II; partitions that secure the apparatus of figure IV of embodiment 52 by maintaining the rigidity of the invention and prohibiting any unwanted movements of any other components of the invention they also allow for a rod and or shaft to pass through, figure III; inside view of the outer shaft showing ledges or support systems that secure the apparatus of figure IV of embodiment 52 by maintaining the rigidity of the invention and prohibiting any unwanted movements of the invention these ledges or support systems also allow for a rod and or shaft to pass through as it would be housed inside of the non magnetic encasement of figure I of embodiment 54,
embodiment 54: Electricity Generator Encasement: figure I; non magnetic material encasement which houses rotational energy couplings rotational energy translators generator boxes with thermo coupling and transformer boxes with thermo coupling, figure II; opening which allows for rod and shaft systems to pass through, figure III; transformer box with thermo coupling lining, figure VI; electrical energy transference component, figure V; outside view of the outer shaft as it would be housed inside of the non magnetic encasement of figure I of embodiment 54, figure VI; rotational energy coupling gear or outer shaft rotational energy translator gear as it would be housed inside of the non magnetic encasement of figure I of embodiment 54

### SUMMARY

The invention's configuration is similar to that of a conventional wind turbine. Its mode of operation is also similar to that of a conventional wind turbine except the presented invention does not use wind to initiate rotational energy needed to begin electricity generation. This improved electricity generating turbine has magnetic rotors instead of regular rotors found on wind turbines. These magnetic rotors don't extend outward but are arced and reattached to the turbine. The invention uses a method for initiating rotational energy into the system by means of magnetic repulsion. Utilizing the effects of the exposed portions of like poles of permanent magnets encased inside of the improved rotors. This repulsive effect can only be brought about by removing the magnetic stabilizer from the system which attracts the like poles of the magnets of the rotors and creates as well as maintains the rotors in a state of stasis. The magnetic stabilizer is also provided to perform maintenance as needed.

The stabilizer's telescoping arms rise up, from inside of a housing, into the area between the rotors. The stabilizer housing surrounds the upper portion of the outer shaft just above the rotor connection to the outer shaft. This allows for the rotation of the rotors to be stopped and restarted by R/C or manual control without causing harm to the system or to its operator.

Accordingly there are advantages of having the improved magnetic rotors, to provide a means of creating sustainable clean energy, to provide a turbine that generates electricity without the means of wind power, or hydro-power, and to provide a more eco-friendly, environmentally and economically, electricity generating system.

The invention has an improved electricity generator system that is equipped with a semi-conductor or a thermo coupling lining inside of both the generator box and the transformer box, neither of which are found inside of the generator box nor the transformer box of electricity generators currently in use. Accordingly the advantages provided by the improved lined electrical generator box and transformer box are to provide a means of reintroducing energy lost by the system as heat energy back into the system as electric energy. Heat flows from warmest to coolest, a thermo coupling or semi conductor disposed or lining the space between the warm and cool materials allow heat energy to be obtained directly from the system. This method provides a means to be able to reclaim energy in a technically simple manner at a good level of efficiency. These components also make the invention suitable for a more efficient electricity output due to less loss of energy to the surroundings as heat energy as well as providing a more eco-friendly method of generating electricity.

All components make the invention suitable for longer non involuntary uninterrupted electricity generation as well as performance of maintenance to or on the invention as needed. There are more advantages that can be seen by studying the enclosed drawings and from the enclosed full detailed description.

1. An improvement to the structure of the turbine electricity generator comprising
a plurality of permanent magnetic rotor arrangements comprised of non magnetic material in which a plurality of permanent magnets are encased with one polarized side of said magnets are exposed as a means to allow magnetic repulsion
a plurality of shaft and rod arrangements comprised of non magnetic material upon which said plurality of permanent magnetic rotors are mounted as a means to provide rotational energy
a non magnetic means of allowing said plurality of shaft and rod arrangement to rotate smoothly in clockwise and counter clockwise directions simultaneously a means to support said means to allow said non magnetic means of allowing the plurality of shaft and rod arrangements to rotate smoothly in clockwise and counter clockwise directions simultaneously
an arrangement of non magnetic rotational energy translators coupled to the plurality of shaft and rod arrangements
a plurality of generator boxes which change the translated rotational energy into electricity
a thermocouple lining inside said generator boxes as a means to change heat into electricity
a plurality of transformer boxes coupled to the generator boxes as a means of receiving generated electricity and supplying electrical energy to electricity consumer, storage or electricity network
a thermocouple lining inside of said transformer boxes as a means to change heat into electricity
an arrangement of both permanent magnetic and non magnetic materials situated around an outer shaft of the plurality of shaft and rod arrangements as a means of allowing start, stop and restart of electricity generating process
a means to allow said outer shaft to rotate smoothly while said arrangement of both permanent magnetic and non magnetic materials situated around the outer shaft remains stationary
a means to support the means to allow the outer shaft to rotate smoothly while the arrangement of both permanent magnetic and non magnetic materials situated around the outer shaft remains stationary
A non magnetic means housing the rotational energy connecting elements, the electricity generator boxes and transformer boxes where by when stabilizers are removed from the system rotational energy is initiated and coupled to at least one of the generator boxes routed to the transformer box and transformed into usable electricity then supplied to a electric consumer, storage or electricity network.

2. The plurality of permanent magnetic rotor arrangements of claim 1 are elongated and arced in such a fashion as to form a concentric ring or semi ring when combined with the plurality of shaft and rod arrangements.

3. The plurality of permanent magnetic rotor arrangements combined with the plurality of shaft and rod arrangements of claim 2 can be arranged as a unit horizontally or vertically.

4. The arranged unit of claim 3 can further be arranged in a combination of a single outer rotor accompanied by a plurality of inner rings or a single outer rotor accompanied by just a single inner ring or a single outer rotor accompanied by a single inner rotor or a plurality of outer rings accompanied by a plurality of inner rings or a single outer ring accompanied by a single inner ring.

5. The unit arrangements of claim 4 are further arranged with the outer rotor or outer ring or plurality of outer rings mounted to the outer shaft and inner rod of the vertical unit and just the outer shafts of the horizontal unit, and with the inner rotor or inner plurality of rings or the single inner ring mounted to just the middle shaft of the vertical
unit and just the inner shafts of the horizontal unit.

6. The unit arrangements of claim 5 are further arranged where the single outer rotor is immobile only in the vertical and horizontal units having a single outer rotor accompanied by a single inner ring or a plurality of inner rings.

7. The arrangement of plurality of permanent magnetic and non magnetic material situated around the outer shaft of claim 1 comprised of an encasement consisting of non magnetic material, housing an arrangement of permanent magnetic and non magnetic telescoping arms, an arrangement of non magnetic rotational energy translators coupled to said arrangement of permanent magnetic and non magnetic telescoping arms, a means of manually and by R/C controlling the telescoping ability of the arms and a hole in the encasement as a means to allow the manual controlling of the telescoping ability of the arms.

8. The arrangement of permanent magnetic and non magnetic telescoping arms of claim 7 are comprised of a plurality of a non magnetic cylindrical telescoping outer sectional encasement of approximate dimensions, an arrangement of inward protrudes of an approximate length about the upper brim of all outer sections of encasement serving as a point of interaction for raising all outer sections along with arm an arrangement of outward protrudes of an approximate length about the bottom brim of all outer sections that serve as a point of interaction for raising successor outer sections along with arm that also have an inward protrude of an approximate length extending from said outward protrude about the bottom brim of all sections that serve as a point of interaction for lowering all outer sections along with arm, a threaded cylindrical rod of an approximate length and cross section serving as the point of coupling rotational energy from non magnetic rotational energy translators to the arms, a cylindrical non magnetic shaft of an approximate length and cross section threaded on the inside mounted on said threaded cylindrical rod as a means to allow coupled rotational energy to raise and lower said shaft without rotating the shaft, a non magnetic horizontal bar of an approximate length and cross section mounted to the top of the shaft as a point of initiation of raising and lowering of outer sections along with arm, a slab of magnetic metal of an approximate thickness affixed to horizontal bar, a non magnetic material of an approximate thickness surrounding said slab of metal as a means to cancel magnetic repulsion but allow magnetic attraction, a plurality of permanent magnets mounted on the non magnetic material arranged with like poles facing each other attracted to the slab of magnetic metal, a battery powered motor as a point of initiating rotational energy to rotational energy translators by a means of R/C control, a threaded key as a point of initiating rotational energy to rotational energy translators that fits inside of said hole of claim 7.
